(19) United States
(12) Patent Application Publication
(10) Pub. No.: US 2023/0144423 A1
(43) Pub. Date: May 11, 2023

(54) SYSTEMS AND METHODS FOR POWER CONSERVATION IN WIRELESS NETWORKS

(71) Applicants: Georgia Tech Research Corporation, Atlanta, GA (US); King Fahd University of Petroleum and Minerals, Dharan (SA)

(72) Inventors: Varun Amar Reddy, Atlanta, GA (US); Gordon Stuber, Atlanta, GA (US); Suhail Al-Dharrab, Dhahran (SA)

(21) Appl. No.: 17/915,530

(22) PCT Filed: Apr. 1, 2021
(86) PCT No.: PCT/US2021/025325

§ 371 Date: Sep. 29, 2022

Related U.S. Application Data
(60) Provisional application No. 63/004,568, filed on Apr. 3, 2020.

(51) Int. Cl. H04W 52/02

(52) U.S. Cl. CPC H04W 52/0216; H04W 52/0248

(57) ABSTRACT

Systems and methods for power conservation via frame aggregation in a wireless network. A station may enter low-power sleep mode for a prescribed duration and subsequently transmit or receive either a burst transmission or an aggregate frame comprising a prescribed amount of data. The prescribed duration and amount of data may be analytically characterized in terms of the arrival rate of data, latency, power consumption, and various additional parameters in the wireless network. The systems and methods can be applied to conserve power in data-intensive high-rate wireless mesh networks, finding application in cellular backhaul, mm wave small cell networks, oil and gas exploration, and wide area monitoring.

### CROSS-REFERENCE TO RELATED APPLICATIONS

This application claims benefit under 35 USC § 119(e) of U.S. Provisional Patent Application No. 62/004,568 filed 3 Apr. 2020, the entirety of which is incorporated herein by reference as if set forth herein in their entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The current disclosure generally relates to wireless data communication, and in particular to systems and methods for power conservation in wireless networks using frame aggregation.

### 2. Description of Related Art

Global internet traffic is growing at an unprecedented rate. There has been a corresponding reduction in cell sizes in order to eliminate coverage holes and deliver high data transfer rates to cell-edge devices.

IEEE 802.11 is part of the IEEE 802 set of local area network (LAN) technical standards and specifies the set of medium access control (MAC) layer and physical (PHY) layer protocols for implementing wireless LAN (WLAN) computer communication. IEEE 802.11ad defines a PHY for 802.11 networks to operate in the 60 GHz millimeter wave spectrum. This frequency band has significantly different propagation characteristics than the 2.4 GHz and 5 GHz bands where Wi-Fi networks operate. The peak transmission rate of 802.11ad is 7 Gbit/s. IEEE 802.11ad is a protocol used for very high data rates and for relatively short range communication (about 1-10 meters).

As just a specific example, wireless networks for environmental monitoring and surveying are experiencing tremendous growth in size and data quality as well. For instance, in oil and gas exploration, a total of 10,000 to 30,000 sensor nodes are deployed across an area of 100-300 square kilometers. Given that each sensor node typically generates data at a rate of 144 Kbps, the aggregate data rate at the sink node can be on the order of several Gigabits per second. Real-time acquisition at the sink node can enable the survey crew to increase productivity and drastically reduce carbon footprint.

The IEEE 802.11 protocol suite is an attractive option for wireless technologies that deliver high data rates and could deliver benefits when used for environmental monitoring and surveying given its unlicensed nature, low cost, and widespread availability of off-the-shelf hardware.

Frame aggregation is a technique utilized by the IEEE 802.11 standard to combine several individual data frames into a single aggregate frame for improved efficiency by eliminating recurring occurrences of control information (overhead). A reduction in the overhead can drastically enhance the overall throughput that can be achieved over a communication link, thereby making high-rate applications feasible.

However, there is a lack of technology that can provide considerable power savings in a wireless network employing the frame aggregation technique. A reduction of the power consumption is of paramount importance in both cellular networks and wireless LANs, particularly in high-rate applications that are known to be more power-hungry.

Conventional wireless networks employing frame aggregation include those disclosed in U.S. Pat. Nos. 10,206,168, 8,730,878 and 7,590,118, where a station that is receiving an aggregate frame can infer from some embedded schedule information whether the frame is intended for it or not. The station can accordingly suspend the reception of the remainder of the aggregate frame and enter low-power operation. Similar extensions are made to the multi-rate multi-user scenario in U.S. Pat. No. 7,983,203 and US Patent Publication No. 2006/0078001. In U.S. Pat. No. 7,733,835, the schedule information is sent as a separate control frame, prior to the aggregate frame. In US Patent Publication No. 2007/0191052, extensions are made to the automatic power save delivery (APSD) scheme in IEEE 802.11n through frame aggregation. However, the size of the aggregate frame and duration of low-power operation (at the transmitting node) are not considered in these systems.

US Patent Publication No. 2018/0109463 and EP Patent No. 2451114 disclose that the buffer size at the receiving node is considered while preparing an aggregate frame for transmission. Additional factors such as congestion in the wireless network (U.S. Pat. No. 8,873,393) and interference (U.S. Pat. Nos. 9,319,926, 9,826,429 and 9,420,600) have been considered while determining the frame aggregation policy, albeit ignoring the aspect of power conservation. In CN Unexamined Patent Application No. 106455021A, an aggregate frame is created after a certain threshold is reached, the threshold either being a certain number of data frames or a certain time threshold. After the transmission of the aggregate frame, the system switches to low-power operation. However, CN 106455021A is silent on a duration for such a low-power operation, and what parameters such a duration would be based on.

Thus, technological innovation is needed to provide power savings in a wireless network employing the frame aggregation technique and/or a low-power mode. Thus, one focus of the present invention concerns the use of frame aggregation as a means to minimize the power consumption in large-scale wireless mesh networks. Another focus of the present invention concerns the use of a low-power sleep mode as a means to minimize the power consumption in large-scale wireless mesh networks. Power saving performance can be from an approximately 78% drop (and more) in total power consumption under such improvement(s) as compared to the classical scenario (where there is no use of frame aggregation and/or a sleep duration imposed on sub-links).

### BRIEF SUMMARY OF THE INVENTION

Briefly described, according to exemplary embodiments of the present invention, systems and methods employ low-power sleep modes when the maximum achievable data rate of a communication link exceeds the arrival rate of data at a wireless relay node. In such scenarios, a period of low-power sleep mode can be imposed at the device to conserve power without compromising the desired quality-of-service from the perspective of the information sink. The duration of the low-power sleep mode and the amount of data to be transmitted or received thereafter can be adjusted to achieve power-optimal performance across the entire wireless network.

In an exemplary embodiment of the present invention, a method for power conservation in a wireless network includes determining an arrival rate of data at a station (or an access point) and an amount of data for transmission. The method may include operation in low-power sleep mode for a duration determined by the arrival rate of data and the amount of data scheduled for transmission. At the expiration of the duration, the method may include the continuous transmission of data in the form of several individual data frames (referred to as frame bursting). Alternatively, the method may include the continuous transmission of data in the form of one or more aggregate frames (referred to as frame aggregation).

In another exemplary embodiment of the present invention, an apparatus for wireless communication serves as an access point or a station. The apparatus may be equipped with one or more memory units that can store computer program code, and one or more processors that can access the memory units and execute the relevant components of the computer program code. The apparatus may also be equipped with a transmitter. The apparatus may be configured to determine an arrival rate of data and an amount of data for transmission. The apparatus may be configured to operate in low-power sleep mode for a duration determined by the arrival rate of data and the amount of data scheduled for transmission. At the expiration of the duration, the apparatus may be configured to continuously transmit the data in the form of several individual data frames. Alternatively, the apparatus may be configured to continuously transmit the data in the form of one or more aggregate frames.

In another exemplary embodiment of the present invention, a method for power conservation in a wireless network includes determining an arrival rate of data at a station (or an access point) and an amount of data for reception. The method may include operation in low-power sleep mode for a duration determined by the arrival rate of data and the amount of data scheduled for reception. At the expiration of the duration, the method may include the continuous reception of data in the form of several individual data frames. Alternatively, the method may include the continuous reception of data in the form of one or more aggregate frames.

In another exemplary embodiment of the present invention, an apparatus for wireless communication serves as an access point or a station. The apparatus may be equipped with one or more memory units that can store computer program code, and one or more processors that can access the memory units and execute the relevant components of the computer program code. The apparatus may also be equipped with a receiver. The apparatus may be configured to determine an arrival rate of data and an amount of data for reception. The apparatus may be configured to operate in low-power sleep mode for a duration determined by the arrival rate of data and the amount of data scheduled for reception. At the expiration of the duration, the apparatus may be configured to continuously receive the data in the form of several individual data frames. Alternatively, the apparatus may be configured to continuously receive the data in the form of one or more aggregate frames.

In another exemplary embodiment of the present invention, a method of controlling power consumption of an electronic device in a wireless network comprises operating the electronic device over a time period comprising operating the electronic device in a low-power sleep mode for a sleep mode duration in the time period, and operating the electronic device in an active mode for an active mode duration in the time period, wherein in the active mode, the electronic device is configured to transmit or receive an active mode amount of data via a burst transmission or an aggregate frame transmission, wherein a power consumption of the electronic device during the time period operating in the low-power sleep mode is approximately at least 78% less than a power consumption of the electronic device during the time period without operating in the low-power sleep mode.

The power consumption of the electronic device during the time period operating in the low-power sleep mode can be approximately at least 87% less than the power consumption of the electronic device during the time period without operating in the low-power sleep mode.

The sleep mode duration can be based at least in part upon a data arrival rate. The sleep mode duration can be based upon the arrival rate of the wireless data and the active mode amount of data.

The electronic device can have a maximum data communication rate, and the electronic device can operate in the low-power sleep mode when the maximum data communication rate exceeds the data arrival rate.

The burst transmission can comprise a continuous transmission of individual data frames. The aggregate frame transmission can comprise a continuous transmission of one or more aggregate frames.

The active mode amount of data can be determined as a function of one or more parameters selected from the group consisting of latency, power consumption, uniformity of power consumption, quality-of-service (or traffic category of the data), buffer size, communication rate (or MCS index), and transmission power.

The active mode amount of data can be based upon a requirement imposed by one or more of the electronic device, another device of the wireless network, and/or a backbone network associated with the wireless network. The requirement can be selected from the group consisting of power consumption, latency, buffer size, a traffic category of data, uniformity of power consumption, communication rate, and transmission power.

The active mode amount of data can be based upon a power consumption requirement imposed by one or more of the electronic device, another device of the wireless network, and/or a backbone network associated with the wireless network. The active mode amount of data can be based upon a latency requirement imposed by one or more of the electronic device, another device of the wireless network, and/or a backbone network associated with the wireless network. The active mode amount of data can be based upon a buffer size requirement imposed by one or more of the electronic device, another device of the wireless network, and/or a backbone network associated with the wireless network. The active mode amount of data can be based upon a traffic category of data requirement imposed by one or more of the electronic device, another device of the wireless network, and/or a backbone network associated with the wireless network. The active mode amount of data can be based upon a uniformity of power consumption requirement imposed by one or more of the electronic device, another device of the wireless network, and/or a backbone network associated with the wireless network.

The active mode amount of data can be based upon a communication rate of a communication link associated with the electronic device. The active mode amount of data can be based upon a transmission power of the electronic device.

In another exemplary embodiment, the present invention is a method of controlling power consumption of an electronic device in a wireless network comprising operating the electronic device in low-power sleep mode for a sleep mode duration, and operating the electronic device in an active mode, wherein in the active mode, the electronic device is configured to transmit or receive an active mode amount of data via a burst transmission or an aggregate frame transmission, wherein the sleep mode duration is based at least in part upon a data arrival rate.

The electronic device can have a maximum data communication rate, wherein the electronic device operates in the low-power sleep mode when the maximum data communication rate exceeds the data arrival rate.

The sleep mode duration can be based upon the arrival rate of the wireless data and the active mode amount of data.

The burst transmission can comprise a continuous transmission of individual data frames. The aggregate frame transmission can comprise a continuous transmission of one or more aggregate frames.

The active mode amount of data can be determined as a function of one or more parameters selected from the group consisting of latency, power consumption, uniformity of power consumption, quality-of-service (or traffic category of the data), buffer size, communication rate (or MCS index), and transmission power.

The active mode amount of data can be based upon a requirement imposed by one or more of the electronic device, another device of the wireless network, and/or a backbone network associated with the wireless network. The requirement can be selected from the group consisting of power consumption, latency, buffer size, a traffic category of data, uniformity of power consumption, communication rate, and transmission power.

The active mode amount of data can be based upon a power consumption requirement imposed by one or more of the electronic device, another device of the wireless network, and/or a backbone network associated with the wireless network. The active mode amount of data can be based upon a latency requirement imposed by one or more of the electronic device, another device of the wireless network, and/or a backbone network associated with the wireless network. The active mode amount of data can be based upon a buffer size requirement imposed by one or more of the electronic device, another device of the wireless network, and/or a backbone network associated with the wireless network. The active mode amount of data can be based upon a traffic category of data requirement imposed by one or more of the electronic device, another device of the wireless network, and/or a backbone network associated with the wireless network. The active mode amount of data can be based upon a uniformity of power consumption requirement imposed by one or more of the electronic device, another device of the wireless network, and/or a backbone network associated with the wireless network.

The active mode amount of data can be based upon a communication rate of a communication link associated with the electronic device. The active mode amount of data can be based upon a transmission power of the electronic device.

The method can further comprise determining the data arrival rate, and determining the active mode amount of data, wherein the sleep mode duration is chosen as a function of the determined data arrival rate and the determined active mode amount of data.

The data arrival rate can be determined using a deterministic technique. The data arrival rate can be determined using a statistical technique.

In exemplary embodiments, the various methods of the present invention can comprise computer-implemented methods. Further, the present invention can comprise a non-transitory computer-readable medium having stored thereon computer-readable instructions executable to cause a computer to perform the various methods disclosed.

For example, in another exemplary embodiment of the present invention, a computer-implemented method of controlling power consumption of an electronic device in a wireless network comprising operating the electronic device in low-power sleep mode for a sleep mode duration, and operating the electronic device in an active mode, wherein in the active mode, the electronic device is configured to transmit or receive an active mode amount of data via a burst transmission or an aggregate frame transmission, wherein the sleep mode duration is based at least in part upon a data arrival rate.

The computer-implemented method can further comprise determining the data arrival rate, and determining the active mode amount of data, wherein the sleep mode duration is chosen as a function of the determined data arrival rate and the determined active mode amount of data.

As another example, in another exemplary embodiment of the present invention, a non-transitory computer-readable medium has stored thereon computer-readable instructions executable to cause a computer to perform a method for controlling power consumption of at least a first station in a wireless network, the method comprising operating the electronic device in low-power sleep mode for a sleep mode duration, and operating the electronic device in an active mode, wherein in the active mode, the electronic device is configured to transmit or receive an active mode amount of data via a burst transmission or an aggregate frame transmission, wherein the sleep mode duration is based at least in part upon a data arrival rate.

The non-transitory computer-readable medium can cause the computer to perform the method further comprising determining the data arrival rate, and determining the active mode amount of data, wherein the sleep mode duration is chosen as a function of the determined data arrival rate and the determined active mode amount of data.

In another exemplary embodiment, the present invention is a method of controlling power consumption of one or more stations in a wireless network comprising operating a first transmitter of a first station in the wireless network in a first transmitter low-power sleep mode for a first sleep mode duration, and subsequently operating the first transmitter to continuously transmit a first amount of data via a burst transmission or an aggregate frame transmission, wherein the first sleep mode duration is based at least in part upon a first arrival rate of data at the first station.

The method can further comprise determining the first arrival rate of data, and determining the first amount of data, wherein the first sleep mode duration is chosen as a function of the determined first arrival rate of data and the determined first amount of data.

The transmission of the first amount of data can comprise a multicast transmission that is destined for reception by a plurality of other stations in the wireless network.

The burst transmission can comprise a continuous transmission of individual data frames, wherein the aggregate frame transmission can comprise a continuous transmission of one or more aggregate frames, and wherein the transmission of the first amount of data can comprise a multicast transmission that supports a unique rate for each of the individual data frames or aggregate frames.

The method can further comprise operating a second receiver of a second station in the wireless network in a second receiver low-power sleep mode for the first sleep mode duration, and subsequently operating the second receiver to continuously receive the first amount of data in the form of the burst transmission or the aggregate frame transmission.

The method can further comprise determining a second arrival rate of data at the second station, operating a second transmitter of the second station in a second transmitter low-power sleep mode for a second sleep mode duration, and subsequently operating the second transmitter to continuously transmit a second amount of data via a burst transmission or an aggregate frame transmission, wherein the second sleep mode duration is based on the second arrival rate of data and the second amount of data.

The method can further comprise operating a third receiver of a third station in the wireless network in a third receiver low-power sleep mode for the second sleep mode duration, and subsequently operating the third receiver to continuously receive the second amount of data in the form of the burst transmission or the aggregate frame transmission.

A communication link between the first transmitter and the second receiver can operate concurrently with a communication link between the second transmitter and the third receiver.

The communication link between the first transmitter and the second receiver can operate over a frequency band F1, wherein the communication link between the second transmitter and the third receiver operates over a frequency band F2, and wherein the frequency bands F1 and F2 are distinct from one another.

The method can further comprise operating the second receiver in a wake-up mode for a wake-up mode duration, wherein the second receiver is configured to receive a transmission from a third station in the wireless network, wherein a duration of the transmission from the third station is at least approximately equal to the wake-up mode duration, and wherein the wake-up mode duration is less than or equal to the first sleep mode duration.

In another exemplary embodiment, the present invention is a method of controlling power consumption of one or more stations in a wireless network comprising operating a first receiver of a first station in the wireless network in a first receiver low-power sleep mode for a first sleep mode duration, and subsequently operating the first receiver to continuously receive a first amount of data via a burst transmission or an aggregate frame transmission, wherein the first sleep mode duration is based at least in part upon a first arrival rate of data at the first station.

The method can further comprise determining the first arrival rate of data, and determining the first amount of data, wherein the first sleep mode duration is chosen as a function of the first arrival rate of data and the first amount of data.

The first amount of data can be based upon a requirement imposed by one or more of the first station device, another entity of the wireless network, and/or a backbone network associated with the wireless network. The requirement can be selected from the group consisting of power consumption, latency, buffer size, a traffic category of data, uniformity of power consumption, communication rate, and transmission power.

The first amount of data can be based upon a power consumption requirement imposed by one or more of the first station device, another entity of the wireless network, and/or a backbone network associated with the wireless network. The first amount of data can be based upon a latency requirement imposed by one or more of the first station device, another entity of the wireless network, and/or a backbone network associated with the wireless network. The first amount of data can be based upon a buffer size requirement imposed by one or more of the first station device, another entity of the wireless network, and/or a backbone network associated with the wireless network. The first amount of data can be based upon a traffic category of data requirement imposed by one or more of the first station device, another entity of the wireless network, and/or a backbone network associated with the wireless network. The first amount of data can be based upon a uniformity of power consumption requirement imposed by one or more of the first station device, another entity of the wireless network, and/or a backbone network associated with the wireless network.

The first amount of data can be based upon a communication rate of a communication link associated with the first station. The first amount of data can be based upon a transmission power of the first station.

In another exemplary embodiment, the present invention is a method of controlling power consumption of at least two electronic devices in a wireless network comprising determining a first data arrival rate at a first electronic device in the wireless network, determining a first amount of data for transmission by the first electronic device to a second electronic device in the wireless network, and synchronously operating the first electronic device and the second electronic device in a low-power sleep mode for a common duration, followed by a continuous transmission by the first electronic device, and continuous reception by the second electronic device, of the first amount of data in the form of individual data frames or in the form of one or more aggregate frames, wherein the common duration of the low-power sleep modes is chosen as a function of the first data arrival rate and the first amount of data.

The transmission of the first amount of data can comprise a multicast transmission that is destined for reception by the second electronic device and other electronic devices in the wireless network.

The transmission of the first amount of data can comprise a multicast transmission that supports a unique rate for each of the individual data frames or aggregate frames.

The method can further comprise determining a second arrival rate of data at the second electronic device, operating a transmitter of the second electronic device in a transmitter low-power sleep mode for a sleep mode duration, and subsequently operating the transmitter to continuously transmit the second amount of data via a burst transmission or an aggregate frame transmission, wherein the sleep mode duration is based on the second arrival rate of data and the second amount of data.

The method can further comprise operating a receiver of a third electronic device in the wireless network in a receiver low-power sleep mode for the sleep mode duration, and subsequently operating the third receiver to continuously receive the second amount of data in the form of the burst transmission or the aggregate frame transmission.

A communication link between the first electronic device and the second electronic device can operate concurrently with a communication link between the second electronic device and the third electronic device.

The communication link between the first electronic device and the second electronic device can operate over a frequency band F1, wherein the communication link between the second electronic device and the third electronic device operates over a frequency band F2, and wherein the frequency bands F1 and F2 are distinct from one another.

The method can further comprise operating the second electronic device in a wake-up mode for a wake-up mode duration, wherein the second electronic device is configured to receive a transmission from a third electronic device in the wireless network, wherein a duration of the transmission from the third electronic device is at least approximately equal to the wake-up mode duration, and wherein the wake-up mode duration is less than or equal to the common duration.

In an exemplary embodiment, the present invention is a method of controlling power consumption of stations in a wireless network comprising operating a first transmitter of a first station in the wireless network in a first transmitter low-power sleep mode for a first sleep mode duration, operating a second receiver of a second station in the wireless network in a second receiver low-power sleep mode for the first sleep mode duration, and operating a second transmitter of the second station in a second transmitter low-power sleep mode for a second sleep mode duration, wherein after the first sleep mode duration, the first transmitter continuously transmits a first amount of data via a burst transmission or an aggregate frame transmission, wherein after the first sleep mode duration, the second receiver continuously receives the first amount of data via the burst transmission or the aggregate frame transmission, wherein after the second sleep mode duration, the second transmitter continuously transmits a second amount of data via a burst transmission or an aggregate frame transmission, wherein the first sleep mode duration is based on a first arrival rate of data to the first station and the first amount of data, and wherein the second sleep mode duration is based on a second arrival rate of data to the second station and the second amount of data.

The method can further comprise determining the first arrival rate of data, determining the first amount of data, determining the second arrival rate of data, and determining the second amount of data.

The first transmitter can have a first maximum data communication rate, wherein the second transmitter has a second maximum data communication rate, wherein the first transmitter operates in the first low-power sleep mode when the first maximum data communication rate exceeds the first arrival rate of data, and wherein the second transmitter operates in the second low-power sleep mode when the second maximum data communication rate exceeds the second arrival rate of data.

The first amount of data and the second amount of data can each be based upon a requirement imposed by one or more the first station, the second station, another station of the wireless network, and/or a backbone network associated with the wireless network. The requirement is selected from the group consisting of power consumption, latency, buffer size, a traffic category of data, uniformity of power consumption, communication rate, and transmission power.

Either or both the first arrival rate of data and the second arrival rate of data can be determined using a deterministic technique. Either or both the first arrival rate of data and the second arrival rate of data can be determined using a statistical technique.

The transmission of the first amount of data can comprise a multicast transmission that is destined for reception by the second receiver and a plurality of other stations in the wireless network.

The transmission of the second amount of data can comprise a multicast transmission that is destined for reception by a plurality of other stations in the wireless network.

The burst transmission of the first amount of data can comprise a continuous transmission of individual data frames, wherein the aggregate frame transmission of the first amount of data can comprise a continuous transmission of one or more aggregate frames, and wherein the transmission of the first amount of data can comprise a multicast transmission that supports a unique rate for each of the individual data frames or aggregate frames.

The burst transmission of the second amount of data can comprise a continuous transmission of individual data frames, wherein the aggregate frame transmission of the second amount of data can comprise a continuous transmission of one or more aggregate frames, and wherein the transmission of the second amount of data can comprise a multicast transmission that supports a unique rate for each of the individual data frames or aggregate frames.

The method can further comprise operating a third receiver of a third station in the wireless network in a third receiver low-power sleep mode for the second sleep mode duration, and subsequently operating the third receiver to continuously receive the second amount of data in the form of the burst transmission or the aggregate frame transmission.

A communication link between the first transmitter and the second receiver can operate concurrently with a communication link between the second transmitter and the third receiver.

The communication link between the first transmitter and the second receiver can operate over a frequency band F1, wherein the communication link between the second transmitter and the third receiver operates over a frequency band F2, and wherein the frequency bands F1 and F2 are distinct from one another.

The method can further comprise operating the second receiver in a wake-up mode for a wake-up mode duration, wherein the second receiver is configured to receive a transmission from a third station in the wireless network, wherein a duration of the transmission from the third station is at least approximately equal to the wake-up mode duration, and wherein the wake-up mode duration is less than or equal to the first sleep mode duration.

As further examples, the present invention can be computer-implemented method of controlling power consumption of one or more stations in a wireless network comprising operating a first transmitter of a first station in the wireless network in a first transmitter low-power sleep mode for a first sleep mode duration, and subsequently operating the first transmitter to continuously transmit a first amount of data via a burst transmission or an aggregate frame transmission, wherein the first sleep mode duration is based at least in part upon a first arrival rate of data at the first station.

The computer-implemented method can further comprise determining the first arrival rate of data, and determining the first amount of data, wherein the first sleep mode duration is chosen as a function of the determined first arrival rate of data and the determined first amount of data.

The computer-implemented method can further comprise operating a second receiver of a second station in the wireless network in a second receiver low-power sleep mode for the first sleep mode duration, and subsequently operating the second receiver to continuously receive the first amount of data in the form of the burst transmission or the aggregate frame transmission.

The computer-implemented method can further comprise determining a second arrival rate of data at the second station, operating a second transmitter of the second station in a second transmitter low-power sleep mode for a second sleep mode duration, and subsequently operating the second transmitter to continuously transmit a second amount of data via a burst transmission or an aggregate frame transmission, wherein the second sleep mode duration is based on the second arrival rate of data and the second amount of data.

The computer-implemented method can further comprise operating the second receiver in a wake-up mode for a wake-up mode duration, wherein the second receiver is configured to receive a transmission from a third station in the wireless network, wherein a duration of the transmission from the third station is at least approximately equal to the wake-up mode duration, and wherein the wake-up mode duration is less than or equal to the first sleep mode duration.

As further examples, the present invention can be a non-transitory computer-readable medium having stored thereon computer-readable instructions executable to cause a computer to perform a method for controlling power consumption of at least a first station in a wireless network, the method comprising operating a first receiver of a first station in the wireless network in a first receiver low-power sleep mode for a first sleep mode duration, and subsequently operating the first receiver to continuously receive a first amount of data via a burst transmission or an aggregate frame transmission, wherein the first sleep mode duration is based at least in part upon a first arrival rate of data at the first station.

The non-transitory computer-readable medium can cause the computer to perform the method further comprising determining the first arrival rate of data, and determining the first amount of data, wherein the first sleep mode duration is chosen as a function of the first arrival rate of data and the first amount of data.

In an exemplary embodiment, the present invention is a non-transitory computer-readable medium having stored thereon computer-readable instructions executable to cause a computer to perform a method for controlling power consumption of at least a first station in a wireless network, the method comprising determining a first data arrival rate at a first electronic device in the wireless network, determining a first amount of data for transmission by the first electronic device to a second electronic device in the wireless network, and synchronously operating the first electronic device and the second electronic device in a low-power sleep mode for a common duration, followed by a continuous transmission by the first electronic device, and continuous reception by the second electronic device, of the first amount of data in the form of individual data frames or in the form of one or more aggregate frames, wherein the common duration of the low-power sleep modes is chosen as a function of the first data arrival rate and the first amount of data.

The non-transitory computer-readable medium can cause the computer to perform the method further comprising determining a second arrival rate of data at the second electronic device, operating a transmitter of the second electronic device in a transmitter low-power sleep mode for a sleep mode duration, and subsequently operating the transmitter to continuously transmit the second amount of data via a burst transmission or an aggregate frame transmission, wherein the sleep mode duration is based on the second arrival rate of data and the second amount of data.

The non-transitory computer-readable medium can cause the computer to perform the method further comprising operating a receiver of a third electronic device in the wireless network in a receiver low-power sleep mode for the sleep mode duration, and subsequently operating the third receiver to continuously receive the second amount of data in the form of the burst transmission or the aggregate frame transmission.

The non-transitory computer-readable medium can cause the computer to perform the method further comprising operating the second electronic device in a wake-up mode for a wake-up mode duration, wherein the second electronic device is configured to receive a transmission from a third electronic device in the wireless network, wherein a duration of the transmission from the third electronic device is at least approximately equal to the wake-up mode duration, and wherein the wake-up mode duration is less than or equal to the common duration.

In an exemplary embodiment, the present invention is a non-transitory computer-readable medium having stored thereon computer-readable instructions executable to cause a computer to perform a method for controlling power consumption of at least a first station in a wireless network, the method comprising operating a first transmitter of a first station in the wireless network in a first transmitter low-power sleep mode for a first sleep mode duration, operating a second receiver of a second station in the wireless network in a second receiver low-power sleep mode for the first sleep mode duration, and operating a second transmitter of the second station in a second transmitter low-power sleep mode for a second sleep mode duration, wherein after the first sleep mode duration, the first transmitter continuously transmits a first amount of data via a burst transmission or an aggregate frame transmission, wherein after the first sleep mode duration, the second receiver continuously receives the first amount of data via the burst transmission or the aggregate frame transmission, wherein after the second sleep mode duration, the second transmitter continuously transmits a second amount of data via a burst transmission or an aggregate frame transmission, wherein the first sleep mode duration is based on a first arrival rate of data to the first station and the first amount of data, and wherein the second sleep mode duration is based on a second arrival rate of data to the second station and the second amount of data.

The non-transitory computer-readable medium can cause the computer to perform the method further comprising determining the first arrival rate of data, determining the first amount of data, determining the second arrival rate of data, and determining the second amount of data.

The non-transitory computer-readable medium can cause the computer to perform the method further comprising operating a third receiver of a third station in the wireless network in a third receiver low-power sleep mode for the second sleep mode duration, and subsequently operating the third receiver to continuously receive the second amount of data in the form of the burst transmission or the aggregate frame transmission.

The non-transitory computer-readable medium can cause the computer to perform the method further comprising operating the second receiver in a wake-up mode for a wake-up mode duration, wherein the second receiver is configured to receive a transmission from a third station in the wireless network, wherein a duration of the transmission from the third station is at least approximately equal to the wake-up mode duration, and wherein the wake-up mode duration is less than or equal to the first sleep mode duration.

In another exemplary embodiment, the present invention is a system of controlling power consumption of an electronic device in a wireless network comprising memory configured to store data, and one or more processors communicative with the memory configured to operate the electronic device in low-power sleep mode for a sleep mode duration, and operate the electronic device in an active mode, wherein in the active mode, the electronic device is configured to transmit or receive an active mode amount of data via a burst transmission or an aggregate frame transmission, wherein the sleep mode duration is based at least in part upon a data arrival rate.

The electronic device can have a maximum data communication rate, and wherein the one or more processors are further configured to operate the electronic device in the low-power sleep mode when the maximum data communication rate exceeds the data arrival rate.

The sleep mode duration can be based upon the arrival rate of the wireless data and the active mode amount of data.

The burst transmission can comprise a continuous transmission of individual data frames. The aggregate frame transmission can comprise a continuous transmission of one or more aggregate frames.

The active mode amount of data can be determined as a function of one or more parameters selected from the group consisting of latency, power consumption, uniformity of power consumption, quality-of-service (or traffic category of the data), buffer size, communication rate (or MCS index), and transmission power.

The active mode amount of data can be based upon a requirement imposed by one or more of the electronic device, another device of the wireless network, and/or a backbone network associated with the wireless network. The requirement can be selected from the group consisting of power consumption, latency, buffer size, a traffic category of data, uniformity of power consumption, communication rate, and transmission power.

The active mode amount of data can be based upon a power consumption requirement imposed by one or more of the electronic device, another device of the wireless network, and/or a backbone network associated with the wireless network. The active mode amount of data can be based upon a latency requirement imposed by one or more of the electronic device, another device of the wireless network, and/or a backbone network associated with the wireless network. The active mode amount of data can be based upon a buffer size requirement imposed by one or more of the electronic device, another device of the wireless network, and/or a backbone network associated with the wireless network. The active mode amount of data can be based upon a traffic category of data requirement imposed by one or more of the electronic device, another device of the wireless network, and/or a backbone network associated with the wireless network. The active mode amount of data can be based upon a uniformity of power consumption requirement imposed by one or more of the electronic device, another device of the wireless network, and/or a backbone network associated with the wireless network.

The active mode amount of data can be based upon a communication rate of a communication link associated with the electronic device. The active mode amount of data can be based upon a transmission power of the electronic device.

One or more processors can further be configured to determine the data arrival rate, and determine the active mode amount of data, wherein the sleep mode duration is chosen as a function of the determined data arrival rate and the determined active mode amount of data.

The data arrival rate can be determined using a deterministic technique. The data arrival rate can be determined using a statistical technique.

In another exemplary embodiment, the present invention is a system of controlling power consumption of one or more stations in a wireless network comprising memory configured to store data, a first transmitter of a first station in the wireless network, and one or more processors communicative with the memory configured to operate the first transmitter in a first transmitter low-power sleep mode for a first sleep mode duration, and subsequently operate the first transmitter to continuously transmit a first amount of data via a burst transmission or an aggregate frame transmission, wherein the first sleep mode duration is based at least in part upon a first arrival rate of data at the first station.

The one or more processors can further be configured to determine the first arrival rate of data, and determine the first amount of data, wherein the first sleep mode duration is chosen as a function of the determined first arrival rate of data and the determined first amount of data.

The transmission of the first amount of data can comprise a multicast transmission that is destined for reception by a plurality of other stations in the wireless network.

The burst transmission can comprise a continuous transmission of individual data frames, wherein the aggregate frame transmission can comprise a continuous transmission of one or more aggregate frames, and wherein the transmission of the first amount of data can comprise a multicast transmission that supports a unique rate for each of the individual data frames or aggregate frames.

The system can further comprise a second receiver of a second station in the wireless network, wherein the one or more processors can further be configured to operate the second receiver in a second receiver low-power sleep mode for the first sleep mode duration, and subsequently operate the second receiver to continuously receive the first amount of data in the form of the burst transmission or the aggregate frame transmission.

The system can further comprise a second transmitter of the second station, wherein the one or more processors can further be configured to determine a second arrival rate of data at the second station, operate the second transmitter in a second transmitter low-power sleep mode for a second sleep mode duration, and subsequently operate the second transmitter to continuously transmit a second amount of data via a burst transmission or an aggregate frame transmission, wherein the second sleep mode duration is based on the second arrival rate of data and the second amount of data.

The system can further comprise a third receiver of a third station in the wireless network, wherein the one or more processors can further be configured to operate the third receiver in a third receiver low-power sleep mode for the second sleep mode duration, and subsequently operate the third receiver to continuously receive the second amount of data in the form of the burst transmission or the aggregate frame transmission.

A communication link between the first transmitter and the second receiver can operate concurrently with a communication link between the second transmitter and the third receiver.

The communication link between the first transmitter and the second receiver can operate over a frequency band F1, wherein the communication link between the second transmitter and the third receiver operates over a frequency band F2, and wherein the frequency bands F1 and F2 are distinct from one another.

The one or more processors can further be configured to operate the second receiver in a wake-up mode for a wake-up mode duration, wherein the second receiver is configured to receive a transmission from a third station in the wireless network, wherein a duration of the transmission from the third station is at least approximately equal to the wake-up mode duration, and wherein the wake-up mode duration is less than or equal to the first sleep mode duration.

In another exemplary embodiment, the present invention is a system of controlling power consumption of one or more stations in a wireless network comprising memory configured to store data, a first receiver of a first station in the wireless network, and one or more processors communicative with the memory configured to operate the first receiver in a first receiver low-power sleep mode for a first sleep mode duration, and subsequently operate the first receiver to continuously receive a first amount of data via a burst transmission or an aggregate frame transmission, wherein the first sleep mode duration is based at least in part upon a first arrival rate of data at the first station.

The one or more processors can further be configured to determine the first arrival rate of data, and determine the first amount of data, wherein the first sleep mode duration is chosen as a function of the first arrival rate of data and the first amount of data.

The first amount of data can be based upon a requirement imposed by one or more of the first station device, another entity of the wireless network, and/or a backbone network associated with the wireless network. The requirement is selected from the group consisting of power consumption, latency, buffer size, a traffic category of data, uniformity of power consumption, communication rate, and transmission power.

In another exemplary embodiment, the present invention is a system of controlling power consumption of at least two electronic devices in a wireless network comprising memory configured to store data, a first electronic device in the wireless network, a first electronic device in the wireless network, and one or more processors communicative with the memory configured to determine a first data arrival rate at the first electronic device, determine a first amount of data for transmission by the first electronic device to the second electronic device, and synchronously operate the first electronic device and the second electronic device in a low-power sleep mode for a common duration, followed by a continuous transmission by the first electronic device, and continuous reception by the second electronic device, of the first amount of data in the form of individual data frames or in the form of one or more aggregate frames, wherein the common duration of the low-power sleep modes is chosen as a function of the first data arrival rate and the first amount of data.

The transmission of the first amount of data can comprise a multicast transmission that is destined for reception by the second electronic device and other electronic devices in the wireless network.

The transmission of the first amount of data can comprise a multicast transmission that supports a unique rate for each of the individual data frames or aggregate frames.

The one or more processors can further be configured to determine a second arrival rate of data at the second electronic device, operate a transmitter of the second electronic device in a transmitter low-power sleep mode for a sleep mode duration, and subsequently operate the transmitter to continuously transmit the second amount of data via a burst transmission or an aggregate frame transmission, wherein the sleep mode duration is based on the second arrival rate of data and the second amount of data.

The one or more processors can further be configured to operate a receiver of a third electronic device in the wireless network in a receiver low-power sleep mode for the sleep mode duration, and subsequently operate the third receiver to continuously receive the second amount of data in the form of the burst transmission or the aggregate frame transmission.

A communication link between the first electronic device and the second electronic device can operate concurrently with a communication link between the second electronic device and the third electronic device.

The communication link between the first electronic device and the second electronic device can operate over a frequency band F1, wherein the communication link between the second electronic device and the third electronic device operates over a frequency band F2, and wherein the frequency bands F1 and F2 are distinct from one another.

The one or more processors can further be configured to operate the second electronic device in a wake-up mode for a wake-up mode duration, wherein the second electronic device is configured to receive a transmission from a third electronic device in the wireless network, wherein a duration of the transmission from the third electronic device is at least approximately equal to the wake-up mode duration, and wherein the wake-up mode duration is less than or equal to the common duration.

In another exemplary embodiment, the present invention is a system of controlling power consumption of stations in a wireless network comprising memory configured to store data, a first transmitter of a first station in the wireless network, a second receiver of a second station in the wireless network, a second transmitter of the second station, and one or more processors communicative with the memory configured to operate the first transmitter in a first transmitter low-power sleep mode for a first sleep mode duration, operate the second receiver in a second receiver low-power sleep mode for the first sleep mode duration, and operate the second transmitter in a second transmitter low-power sleep mode for a second sleep mode duration, wherein after the first sleep mode duration, the first transmitter continuously transmits a first amount of data via a burst transmission or an aggregate frame transmission, wherein after the first sleep mode duration, the second receiver continuously receives the first amount of data via the burst transmission or the aggregate frame transmission, wherein after the second sleep mode duration, the second transmitter continuously transmits a second amount of data via a burst transmission or an aggregate frame transmission, wherein the first sleep mode duration is based on a first arrival rate of data to the first station and the first amount of data, and wherein the second sleep mode duration is based on a second arrival rate of data to the second station and the second amount of data.

The one or more processors can further be configured to determine the first arrival rate of data, determine the first amount of data, determine the second arrival rate of data, and determine the second amount of data.

The first transmitter can have a first maximum data communication rate, wherein the second transmitter can have a second maximum data communication rate, and wherein the one or more processors can further be configured to operate the first transmitter in the first low-power sleep mode when the first maximum data communication rate exceeds the first arrival rate of data, and operate the second transmitter in the second low-power sleep mode when the second maximum data communication rate exceeds the second arrival rate of data.

The first amount of data and the second amount of data are each based upon a requirement imposed by one or more the first station, the second station, another station of the wireless network, and/or a backbone network associated with the wireless network. The requirement is selected from the group consisting of power consumption, latency, buffer size, a traffic category of data, uniformity of power consumption, communication rate, and transmission power.

Either or both the first arrival rate of data and the second arrival rate of data can be determined using a deterministic technique. Either or both the first arrival rate of data and the second arrival rate of data can be determined using a statistical technique.

The transmission of the first amount of data can comprise a multicast transmission that is destined for reception by the second receiver and a plurality of other stations in the wireless network.

The transmission of the second amount of data can comprise a multicast transmission that is destined for reception by a plurality of other stations in the wireless network.

The burst transmission of the first amount of data can comprise a continuous transmission of individual data frames, wherein the aggregate frame transmission of the first amount of data can comprise a continuous transmission of one or more aggregate frames, and wherein the transmission of the first amount of data can comprise a multicast transmission that supports a unique rate for each of the individual data frames or aggregate frames.

The burst transmission of the second amount of data can comprise a continuous transmission of individual data frames, wherein the aggregate frame transmission of the second amount of data can comprise a continuous transmission of one or more aggregate frames, and wherein the transmission of the second amount of data can comprise a multicast transmission that supports a unique rate for each of the individual data frames or aggregate frames.

The system can further comprise a third receiver of a third station in the wireless network, wherein the one or more processors can further be configured to operate the third receiver in a third receiver low-power sleep mode for the second sleep mode duration, and subsequently operate the third receiver to continuously receive the second amount of data in the form of the burst transmission or the aggregate frame transmission.

A communication link between the first transmitter and the second receiver operates concurrently with a communication link between the second transmitter and the third receiver.

The communication link between the first transmitter and the second receiver operates over a frequency band F1, wherein the communication link between the second transmitter and the third receiver operates over a frequency band F2, and wherein the frequency bands F1 and F2 are distinct from one another.

The one or more processors can further be configured to operate the second receiver in a wake-up mode for a wake-up mode duration, wherein the second receiver is configured to receive a transmission from a third station in the wireless network, wherein a duration of the transmission from the third station is at least approximately equal to the wake-up mode duration, and wherein the wake-up mode duration is less than or equal to the first sleep mode duration.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

Implementations, features, and aspects of the disclosed technology are described in detail herein and are considered a part of the claimed disclosed technology. Other implementations, features, and aspects can be understood with reference to the following detailed description, accompanying drawings, and claims. Wherever possible, the same reference numbers are used throughout the drawings to refer to the same or like elements of an embodiment. Reference will now be made to the accompanying figures and flow diagrams, which are not necessarily drawn to scale.

FIG. 1 is a block diagram of an illustrative computer system architecture 100, according to an exemplary embodiment.

FIG. 2 is a schematic of frame bursting and frame aggregation mechanisms in a wireless network.

FIG. 3 illustrates a wireless network according to an exemplary embodiment of the present invention.

FIG. 4 is a flowchart of an exemplary embodiment of the present invention.

FIG. 5 illustrates an exemplary embodiment of the present invention as a wireless mesh network for backhaul application where the arrival rate of data is depicted for each of the wireless devices.

FIG. 6 illustrates an exemplary embodiment of the present invention in which coexistence mechanisms can be applied between various wireless devices while employing aspects of the present disclosure.

FIG. 7 illustrates an exemplary network architecture according to the present invention.

FIG. 8 is a schematic of overlap in the data transmission periods that leads to co-channel interference (CCI) between two sub-links.

FIGS. 9A, 9B are graphs showing latency and power consumption performance comparisons between classical operation and the Frame Aggregation Power-Saving Backhaul (FA-PSB) scheme (with no latency constraint) (Saudi Arabia (SA) survey).

FIGS. 10A, 10B are graphs showing latency and power consumption performance comparisons between classical operation and the FA-PSB scheme (with no latency constraint) (Texas, USA (TX) survey).

FIGS. 11A, 11B are graphs showing latency and power consumption performance as a function of the data generation rate and the fraction of the total number of links that are obstructed (SA survey).

FIGS. 12A, 12B are graphs showing latency and power consumption performance as a function of the data generation rate and the fraction of the total number of links that are obstructed (TX survey).

FIGS. 13A, 13B are graphs showing performance comparison between the 802.1 lad and 802.11ac standards in terms of the trade-off between the latency and power consumption at a data generation rate of 48 Kbps (SA survey).

FIGS. 14A, 14B are graphs showing performance comparison between the 802.1 lad and 802.11ac standards in terms of the trade-off between the latency and power consumption at a data generation rate of 1 Kbps (SA survey).

### DETAILED DESCRIPTION OF THE INVENTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Using “comprising” or “including” or like terms means that at least the named compound, element, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

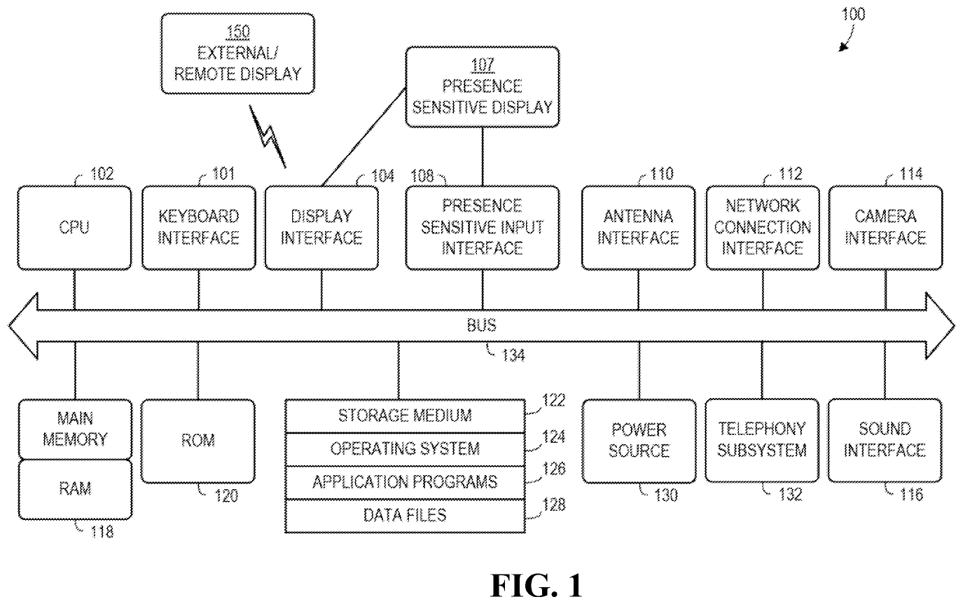

Aspects of the disclosed technology may be implementing using at least some of the components illustrated in the computing device architecture 100 of FIG. 1. As shown, the computing device architecture includes a central processing unit (CPU) 102, where computer instructions are processed; a display interface 104 that acts as a communication interface and provides functions for rendering video, graphics, images, and texts on the display. In certain example implementations of the disclosed technology, the display interface 104 may be directly connected to a local display, such as a touch-screen display associated with a mobile computing device. In another example implementation, the display interface 104 may be configured for providing data, images, and other information for an external/remote display that is not necessarily physically connected to the mobile computing device. For example, a desktop monitor may be utilized for mirroring graphics and other information that is presented on a mobile computing device. In certain example implementations, the display interface 104 may wirelessly communicate, for example, via a Wi-Fi channel or other available network connection interface 112 to the external/remote display.

In an example implementation, the network connection interface 112 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 104 may be operatively coupled to a local display, such as a touch-screen display associated with a mobile device. In another example, the display interface 104 may be configured to provide video, graphics, images, text, other information, or any combination thereof for an external/remote display that is not necessarily connected to the mobile computing device. In one example, a desktop monitor may be utilized for mirroring or extending graphical information that may be presented on a mobile device. In another example, the display interface 104 may wirelessly communicate, for example, via the network connection interface 112 such as a Wi-Fi transceiver to the external/remote display.

The computing device architecture 100 may include a keyboard interface 106 that provides a communication interface to a keyboard. In one example implementation, the computing device architecture 100 may include a presence-sensitive display interface 108 for connecting to a presence-sensitive display 107. According to certain example implementations of the disclosed technology, the presence-sensitive display interface 108 may provide a communication interface to various devices such as a pointing device, a touch screen, a depth camera, etc. which may or may not be associated with a display.

The computing device architecture 100 may be configured to use an input device via one or more of input/output interfaces (for example, the keyboard interface 106, the display interface 104, the presence sensitive display interface 108, network connection interface 112, camera interface 114, sound interface 116, etc.) to allow a user to capture information into the computing device architecture 100. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 100 or may be a separate device. For example, the input device may be an accelerometer, a magnetometer, a digital camera, a microphone, and an optical sensor.

Example implementations of the computing device architecture 100 may include an antenna interface 110 that provides a communication interface to an antenna; a network connection interface 112 that provides a communication interface to a network. As mentioned above, the display interface 104 may be in communication with the network connection interface 112, for example, to provide information for display on a remote display that is not directly connected or attached to the system. In certain implementations, a camera interface 114 is provided that acts as a communication interface and provides functions for capturing digital images from a camera. In certain implementations, a sound interface 116 is provided as a communication interface for converting sound into electrical signals using a microphone and for converting electrical signals into sound using a speaker. According to example implementations, a random access memory (RAM) 118 is provided, where computer instructions and data may be stored in a volatile memory device for processing by the CPU

According to an example implementation, the computing device architecture 100 includes a read-only memory (ROM) 120 where invariant low-level system code or data for basic system functions such as basic input and output (I/O), startup, or reception of keystrokes from a keyboard are stored in a non-volatile memory device. According to an example implementation, the computing device architecture 100 includes a storage medium 122 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 124, application programs 126 (including, for example, a web browser application, a widget or gadget engine, and or other applications, as necessary) and data files 128 are stored. According to an example implementation, the computing device architecture 100 includes a power source 130 that provides an appropriate alternating current (AC) or direct current (DC) to power components.

According to an example implementation, the computing device architecture 100 includes and a telephony subsystem 132 that allows the device 100 to transmit and receive sound over a telephone network. The constituent devices and the CPU 102 communicate with each other over a bus 134.

According to an example implementation, the CPU 102 has appropriate structure to be a computer processor. In one arrangement, the CPU 102 may include more than one processing unit. The RAM 118 interfaces with the computer bus 134 to provide quick RAM storage to the CPU 102 during the execution of software programs such as the operating system application programs, and device drivers. More specifically, the CPU 102 loads computer-executable process steps from the storage medium 122 or other media into a field of the RAM 118 in order to execute software programs. Data may be stored in the RAM 118, where the data may be accessed by the computer CPU 102 during execution. In one example configuration, the device architecture 100 includes at least 98 MB of RAM, and 256 MB of flash memory.

The storage medium 122 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 122, which may comprise a machine-readable storage medium.

According to one example implementation, the term computing device, as used herein, may be a CPU, or conceptualized as a CPU (for example, the CPU 102 of FIG. 1). In this example implementation, the CPU may be coupled, connected, and/or in communication with one or more peripheral devices, such as display. In another example implementation, the term computing device, as used herein, may refer to a mobile computing device such as a smartphone, tablet computer, or smart watch. In this example embodiment, the computing device may output content to its local display and/or speaker(s). In another example implementation, the computing device may output content to an external display device (e.g., over Wi-Fi) such as a TV or an external computing system.

A WLAN is a popular type of a wireless network technology. A WLAN may be used to interconnect various devices together, either in an indoor or outdoor setting. The IEEE 802.11 protocol is a highly popular technology employed in such scenarios. In indoor scenarios, the primary objective may be to deliver reliable data for the purposes of connectivity and entertainment. In outdoor scenarios, point-to-point links can be established in the form of a mesh network for cellular backhaul. Backhaul links may also be deployed across long distances in large-scale environmental surveying/monitoring applications such as oil and gas exploration.

With the proliferation of wireless devices and an ever-growing demand for high-quality data, there is a strong need for wireless technology that can support very high data rates on the order of several Gigabytes per second. Frame aggregation (FA) and frame bursting are two techniques that have been incorporated into the IEEE 802.11 standard that can help improve the overall throughput. As per the working of the IEEE 802.11 standard, each data frame is associated with some inherent overhead in the form of metadata. The metadata may be control signals at the PHY, that deals with the process of automatic gain control, channel estimation, error detection and correction, time synchronization, and frequency carrier offset correction. Additionally, the metadata may indicate MAC layer information such as identification information, the type of data being contained in the payload, the modulation and coding scheme (MCS) being employed, and various other parameters.

With the use of frame bursting and FA, a plurality of such data frames is combined into a single “block” frame such that the overhead is significantly reduced. For instance, the payload duration for a packet of 1500 bytes is around 3 microseconds, considering a 4 Gbps link using the IEEE 802.11ad standard. However, the MAC layer overhead can amount to nearly 60 microseconds, which drastically brings down the effective data rate to just around 0.2 Gbps. Hence, the use of larger data blocks is imperative to achieving a high throughput by diminishing the effect of the overhead.

Those of skill in the art appreciate the MAC layer improvements introduced in the IEEE 802.11n amendment by the IEEE 802.11 working group. Frame bursting and FA were proposed as a part of this amendment, and further enhancements were made in later amendments, such as more efficient integration with the block acknowledgment protocol.

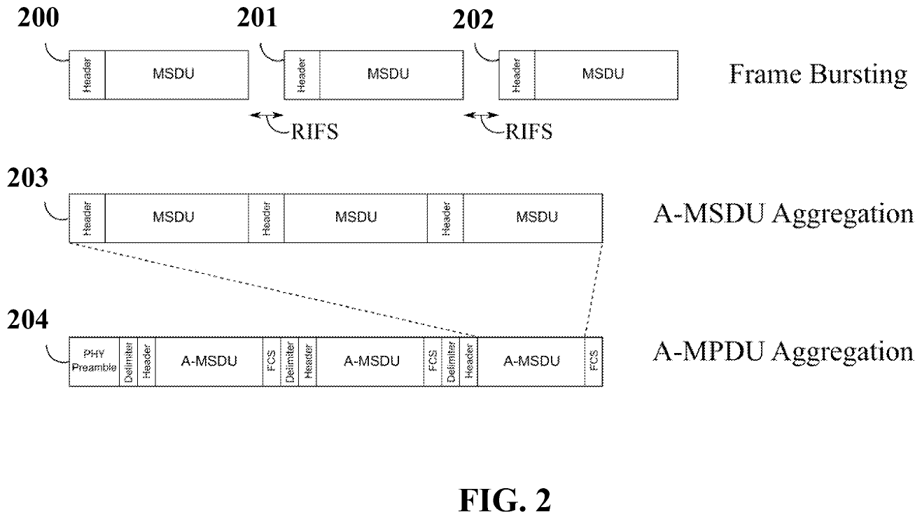

Referring to FIG. 2, the MAC layer organizes data in the form of individual data frames 200, 201, 202 known as MAC service data units (MSDUs). An MSDU comprises a payload portion (containing data from the upper layers of the protocol stack) and a header portion that contains metadata. Typically, after each MSDU is transmitted, an acknowledgement (ACK) frame is expected by the transmitter as per the IEEE 802.11 standard specifications.

A sequence of MSDU-ACK exchanges is highly inefficient, particularly in the case of high-rate protocols such as 802.11ad. In frame bursting, several MSDUs are transferred back-to-back, with adjacent MSDUs being separated in time by the reduced interframe spacing (RIFS). At the end of the burst, a block ACK (BA) is sent back to the transmitter containing information about which of the MSDUs were not received successfully and require retransmission.

The efficiency of data transfer can be further improved through FA, wherein the RIFS period is eliminated and the header fields combined to reduce the impact of the overhead. The resultant frame may be referred to as an aggregate frame. As shown in FIG. 2, several MSDUs may be aggregated to form an Aggregate MSDU (A-MSDU) frame 203. A MAC protocol data unit (MPDU) is formed by attaching additional header and frame check sequence (FCS) fields to an A-MSDU. Several MPDUs may in turn be aggregated to form an Aggregate MAC Protocol Data Unit (A-MPDU) frame 204. The A-MPDU frame is then passed in the egress direction to the PHY layer to form the final payload frame for transmission.

A combination of both A-MSDU and A-MPDU aggregation can be employed as per the IEEE 802.11 standard specifications. The overall effect is a significant reduction of the overhead, and the ability to boost the data rate by forming very large data blocks.

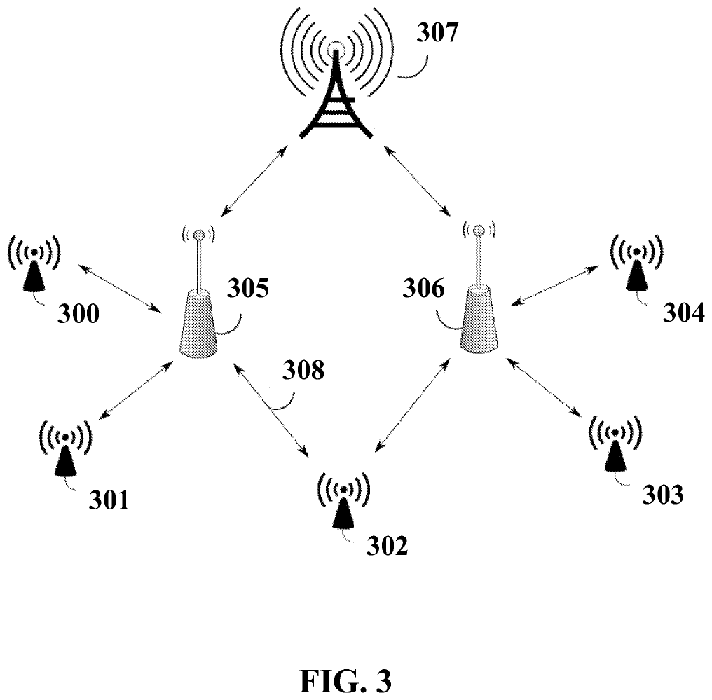

An example wireless network shown in FIG. 3 is a frequent occurrence in modern-day networks. Stations (STAs) 300, 301, 302, 303, 304 exchange data with access points (APs) 305, 306 through bidirectional communication links 308. The APs in turn exchange data with a central data unit (CDU) 307. The CDU may also serve as a gateway node to a larger backbone network.

The bidirectional communication links may be operated as per the IEEE 802.11 standard and may frequently invoke the frame bursting or FA mechanisms. In an exemplary embodiment, the STAs are devices such as smart phones, laptops, smart televisions etc. The APs may be controlled by a CDU that governs the operation of the WLAN(s). In another exemplary embodiment, the APs serve as radio units for small cell coverage and can establish backhaul links to the core network in cellular systems. In another exemplary embodiment, the STAs serve as sensors in an environmental surveying/monitoring system that can find application in oil and gas exploration, weather monitoring, agricultural monitoring, earthquake detection, and other meteorological studies. The APs would serve as relay nodes that transfer data towards the CDU, which in turn governs the operation of the entire monitoring system. In another exemplary embodiment, all the devices in the shown network can exchange data with one another in a mesh topology. Hence, the example wireless network shown in FIG. 3 can be applied to a variety of scenarios.

In addition to sustaining high data rates, there is an equally important need for power conservation to extend the operating time of wireless devices. In particular, achieving the optimal trade-off between latency and power conservation with the use of frame bursting or FA remains an open problem.

The present invention provides power-conserving systems and methods in, for example, a wireless network as shown in FIG. 3. Provided that the achievable rate of communication is greater than the arrival rate of data, a low-power sleep duration can be imposed at each of the devices in the network.

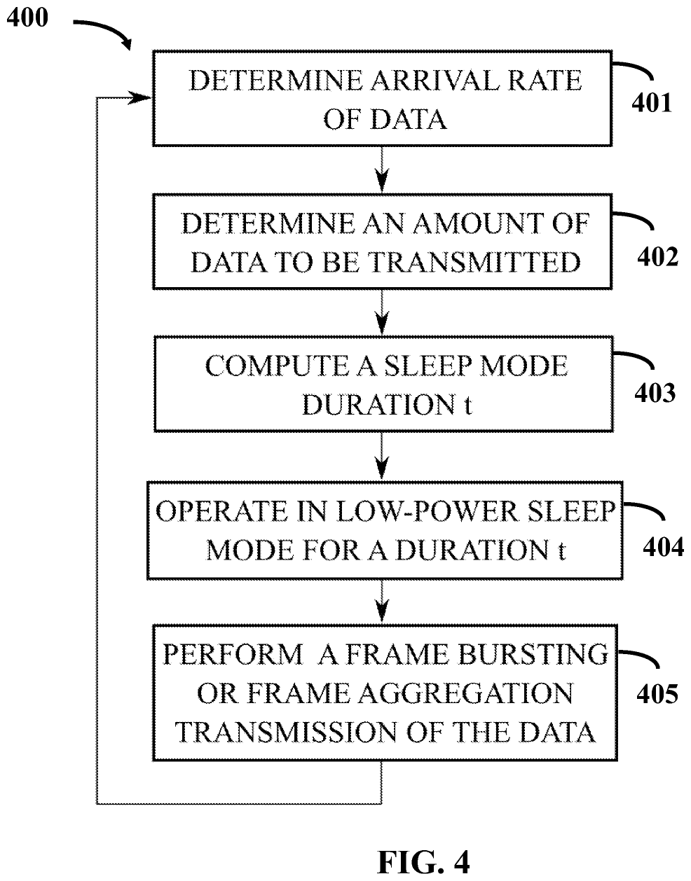

An shown in FIG. 4, primary aspects of the present invention include a method 400, where a wireless device can determine the arrival rate of data at step 401 along with the amount of data to be scheduled for transmission or reception at step 402. This amount of data can be divided across a number of data frames, which in turn are scheduled for transmission.

At step 403, the value for the sleep duration t can be determined as a function of various parameters in addition to the arrival rate of data and the amount of data that is scheduled for transmission or reception. The wireless device at step 404 may then operate in low-power sleep mode for the prescribed duration t, followed by a frame bursting transmission or a FA transmission step 405. In the case of a receiving device, the sleep duration may be followed by a frame bursting reception or a FA reception. A transmitting device may also operate in unison with another receiving device under a common period of low-power sleep mode and data transfer.

Data may “arrive” at a device as a result of data generation (such as a sensor), and/or through a receiver that decodes incoming transmissions and buffers the data, and/or through a combination of both the aforementioned factors. The arrival rate of data may be computed or estimated through a variety of means. Those of skill in the art can appreciate the use of mathematical models based on queuing theory for determining the arrival rate of data. The model may be deterministic or statistical in nature, based on the type of traffic encountered. In applications such as oil and gas exploration, the traffic pattern is deterministic and suitable models may be applied. In applications such as cellular backhaul, the traffic pattern may be modeled using statistical distributions such as the Poisson model. Alternatively, a custom empirical model may be applied by the wireless device to determine the arrival rate of data. The value of the computed arrival rate may also be modified as per any data compression algorithms that are applied by the device.

The amount of data to be scheduled for transmission (or reception) may be computed as a function of various parameters in the wireless device and the wireless network. Such parameters include, but are not limited, to the latency, power consumption, uniformity of power consumption, quality-of-service (or traffic category of the data), buffer size, communication rate (or MCS index), and transmission power at each of the wireless devices in the wireless network. The amount of data may then be divided across a number of data frames, which in turn are scheduled for transmission (or reception) as per the predefined PHY/MAC layer protocol. The data frames may in turn be transmitted using a frame bursting or a FA mechanism.

Above described aspects of the present invention pertain to individual wireless devices that determine the operating parameters independently of another. Each of these devices operates in a distributed manner that is agnostic to the latency and power consumption requirements that may be desired by the wireless network (or a backbone network) as a whole. In some cases, a central entity may wish to dictate the operation of a larger part of the network under certain constraints.

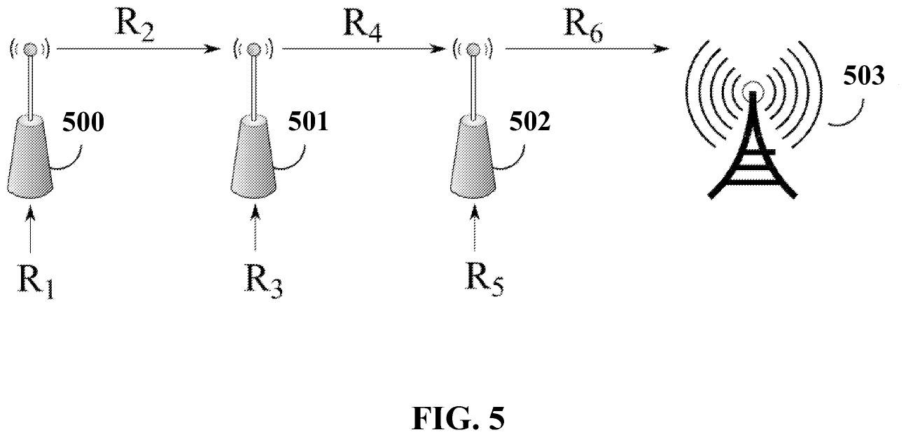

Further aspects of the disclosure are described with reference to FIG. 5 where a mesh network for backhaul application is shown with the arrival rates of data at each of the devices. APs 500, 501, 502 form a mesh network with the objective of relaying or “backhauling” data towards the CDU 403. AP 500 perceives an arrival rate of R₁, AP 501 perceives an arrival rate of (R₂+R₃), AP 502 perceives an arrival rate of (R₄+R₅), and AP 503 perceives an arrival rate of R₆. Those of skill in the art appreciate that in order to maintain a stable queue without introducing exponential delays, the conditions (R₂>R₁), (R₄>R₂₊R₃), and (R₆>R₄₊R₅) would have to be satisfied. Furthermore, there may be latency requirements at the CDU 503 in addition to a power consumption requirement at all the APs. In such a scenario, the number of data frames that are scheduled for transmission and reception at the various APs would have to be jointly solved (on the basis of all the arrival rate values) to obtain the optimal power conservation performance under a latency constraint. APs 500 and 501 may operate in low-power sleep mode in unison, and wake-up at the same time instance such that the transmitter in AP 500 transmits an amount of data towards the receiver in AP 501. A similar approach may be taken by APs 501 and 502, and AP 502 and CDU 503.

Those of skill in the art can appreciate the use of convex approximation methods to capture the effect of the amount of data (that is scheduled for transmission/reception at each of the APs) on the power consumption and the latency. This in turn can yield a convex optimization problem which can be rapidly solved for the globally power-optimal solution using standard techniques. The aforementioned optimization problem can be extended to solve for the optimal MCS index and transmission power for all the APs, under the impact of CCI as well.

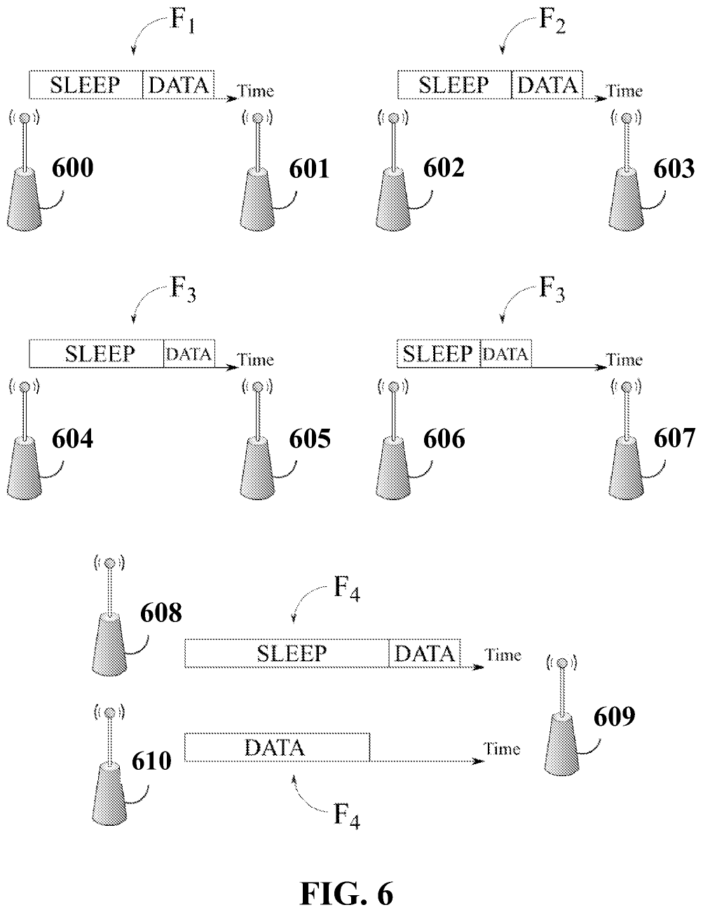

Another aspect of the invention pertains to coexistence between various STAs in a wireless network while applying the aforementioned techniques for power conservation. As shown in FIG. 6, two separate communication links between the STAs may operate concurrently by multiplexing the transmissions either in time or frequency. For instance, the communication links AP 600-AP 601 and AP 602-AP 603 can operate simultaneously on unique frequency channels F₁ and F₂ respectively. Alternatively, transmissions over the communication link AP 604-AP 605 can be performed during the low-power sleep mode duration of the communication link AP 606-AP 607, in order to prevent interference on a common channel F₃. In another embodiment, an external AP 510 can transmit time-sensitive data, over a common channel F₄, during the low-power sleep mode duration imposed at APs 608 and 609. In such a scenario, AP 609 would have to alter its low-power sleep mode duration (that was scheduled in conjunction with AP 608) and wake-up to receive the transmissions from AP 610. In applications such as environmental monitoring and oil and gas exploration, the external AP 610 may be a mobile device such as an unmanned aerial vehicle (UAV) or an autonomous underwater vehicle (AUV) that periodically joins the network to transfer time-sensitive information.

Energy-Efficient Mm-Wave Backhauling Via FA in Wide Area Geophone Networks

As previously discussed, the present systems and methods afford innovation advances in specific situations, for example, in wide area geophone networks. Recent advances in exploration geophysics can generate subsurface images of the Earth with great depth and quality, albeit requiring a large amount of seismic data to be transferred in real-time. While cables are able to meet these requirements, they account for a majority of the equipment weight, maintenance, and labor costs.

In an exemplary embodiment of the present invention, an innovative wireless network architecture compliant with the IEEE 802.11ad standard is disclosed for establishing scalable, energy-efficient, and gigabit-rate backhaul across very large areas. Statistical path-loss and line-of-sight (LoS) models are derived using real-world topographic data in well-known seismic regions. Additionally, a cross-layer analytical model is derived for 802.11 systems that can characterize the overall latency and power consumption under the impact of CCI.

On the basis of these models, an FA-PSB scheme is disclosed for near-optimal power conservation under a latency constraint, through a duty-cycled approach. A performance evaluation with respect to the survey size and data generation rate reveals that the innovative architecture and the FA-PSB scheme can support real-time acquisition in large-scale high-density scenarios, while operating with minimal power consumption, thereby enhancing the lifetime of wireless seismic surveys. The FA-PSB scheme can be applied to cellular backhaul and sensor networks as well.

Wide area data acquisition systems for surveying applications continue to grow in area, node density, and data traffic. In particular, one such challenging application is the operation of seismic surveys for imaging the subsurface layers of the Earth to determine the location and size of oil, gas, and other mineral deposits. Seismic waves are generated by an energy source that are reflected by the subsurface layers, and in turn recorded by devices called geophones that are deployed across the survey area. The data is then accumulated at a data collection center (DCC) and processed to generate a visual image of the Earth's subsurface.

The subject of 2-D and 3-D seismic survey design has been studied. As noted above, a typical survey can deploy 10,000 to 30,000 geophones over an area of 100-300 square kilometers. Given the sheer size of a seismic survey, the use of cable to connect all the geophones accounts for a majority of the equipment weight and cost. Although cable can offer high data rates in a reliable manner, a significant amount of time is spent in troubleshooting problems pertaining to the cables and connectors. Deploying cable in undulated terrain is a challenging task and can pose safety hazards to the crew. Cables can also directly impact the ecosystem of the region. For instance, it has been reported that some length of the cables is chewed upon by animals overnight leading to unmonitored ecological effects in addition to maintenance setbacks in the surveying process.

While wireless systems offer an excellent alternative to cable, they come with the challenging task of achieving high data rates and relaying time-sensitive information over several nodes deployed across a widespread area. Real-time acquisition at the DCC is of vital importance as it enables field engineers to adaptively modify the acquisition parameters and minimize logistical costs. Given a seismic wavefield sampling time of 0.5 ms, a three-component (3-C) geophone with a 24-bit analog-to-digital converter would generate data at a rate of 144 Kbps. For a mid-sized survey comprising 3-C 14,400 geophones, the data rate requirement at the DCC can reach up to 1 Gbps. Larger surveys with higher sampling rates at the geophones would mandate a requirement of nearly 5 Gbps at the DCC. In this regard, geophone networks vary vastly from typical sensor networks where the peak data rate is on the order of a few Kbps. Additionally, power saving schemes must be incorporated since seismic acquisition can be conducted for durations lasting up to thirty days.

The present invention embodied as a wireless geophone network architecture provides high-rate energy-efficient data transfer between the gateway nodes and the DCC, which is a crucial aspect that has not been studied. The IEEE 802.11ad standard is a suitable choice that can sustain data rates of up to 6 Gbps in the 60 GHz unlicensed bands and achieve real-time acquisition at the DCC even for large-scale surveys that impose an acquisition rate requirement of up to 5 Gbps.

A complete latency and power consumption analysis is conducted for gateway nodes that are spread across the entire survey area. Furthermore, an analytical model is extended to include the impact of the transmit power and MCS index at the PHY layer, FA at the MAC layer, and the use of transmission control protocol (TCP) at the transport layer. Multiple source nodes are considered, as opposed to a single source. The present invention uses an FA-PSB scheme for near-optimal power conservation across a large-scale mesh network of gateway nodes, while ensuring real-time data delivery at the sink node. A duty-cycled approach is taken wherein the aforementioned analytical models are applied in determining near-optimal values for the sleep duration and data transmission parameters across the entire network.

Although primarily focused on the use of IEEE 802.11ad in seismic acquisition, the present invention extends to various other applications, such as 5G small-cell mm-wave backhaul, wireless backhaul in heterogeneous networks (HetNets), and sensor networks based on IEEE 802.11 systems for agricultural, environmental, and industrial monitoring purposes.

The present invention incorporates, among other features:
the design of a wireless network architecture for real-time, scalable, standards-compliant, and energy-efficient backhauling across large areas. The architecture is augmented with the inventive FA-PSB scheme that relies on a duty-cycled approach for near-optimal power conservation;
the derivation of a cross-layer analytical model, based on semi-Markov processes and queuing theory, that characterizes the data transfer time and power consumption as a function of the transmit power, MCS index, FA parameters in 802.11, along with the use of TCP; and
the derivation of an optimization framework that yields the parameters for operation under the FA-PSB scheme. A convex mixed-integer non-linear program (MINLP) is formulated and solved to achieve minimum power consumption across the network under the impact of CCI and a latency constraint.

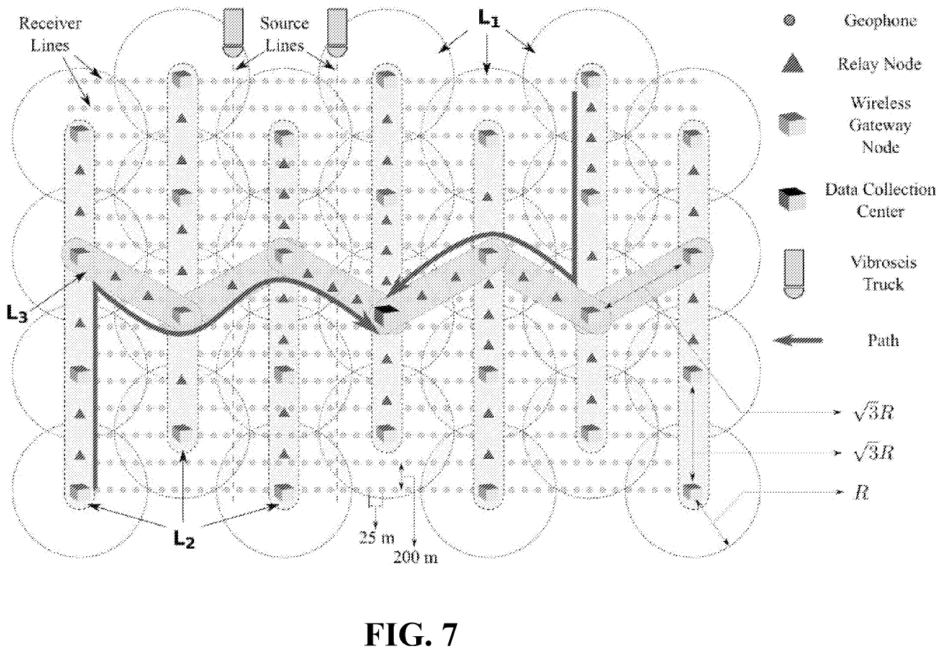

An overview of the seismic survey process is shown in FIG. 7. The geophones can be considered the STAs of FIG. 3. The wireless gateway nodes (WGNs) can be considered the APs of FIG. 3, and the DCC analogous to the CDU.

The geophones are positioned 5-30 meters apart, along a straight line to form a Receiver Line (RL). Vibroseis trucks move along a Source Line (SL) and generate seismic waves, called a “sweep,” for a duration of 8-12 seconds, known as the “sweep length.” Following the sweep length, data is recorded by all the geophones for a duration of 6-8 seconds, known as the “listen interval.” During a “move-up interval” of 8-10 seconds, the vibroseis trucks shift to the next point where a sweep will be conducted. The three operations are repeated periodically across the survey area. A “flip-flop” operation is where two vibroseis trucks that are sufficiently separated in distance can conduct overlapping sweeps to improve the overall productivity. Typically, there is no rigid latency requirement at the DCC. However, a good benchmark would be to acquire all the data from the previous sweep prior to the start of the listen interval of the current sweep, thereby enabling the field engineers to modify the recording parameters at the geophones. Hence, the latency threshold at the DCC can be set to the duration of the sweep length.

An orthogonal geometry is a commonly employed topology in seismic acquisition, wherein the RLs and SLs are perpendicular to one another. FIG. 7 provides an illustration of an exemplary embodiment of the present invention as a network architecture that specifies an inter-geophone distance of 25 meters along the RL, and an inter-RL distance of 200 meters. The bottommost layer of the architecture, L₁, includes the links between WGNs and the geophones. As shown in FIG. 7, the WGNs are laid out in a hexagonal tessellating pattern to minimize CCI, where R is the WGN cell radius defined as the distance from the center to the corner of the hexagon. A variety of communication schemes can be used for operation at the L₁ layer.

The upper L₂ and L₃ layers are organized as a mesh network of WGNs with the DCC being the final sink node. Although both upper layers are part of the same mesh network, the notations L₂ and L₃ serve to demarcate the overall mesh into smaller subnets having either a vertical (L₂) or a horizontal (L₃) orientation. Note that the peak data transfer rates at the L₂ and L₃ layers are significantly higher (0.15-2.5 Gbps) as compared to the L₁ layer (1.5-150 Mbps). Hence, the IEEE 802.11ad standard can be employed at the L₂ and L₃ layers in order to provide a real-time acquisition capability.

To improve the robustness of the architecture, additional relay nodes (RNs) can be deployed uniformly between adjacent WGNs, so as to counter large path losses in the 60 GHz bands or non-line-of-sight (NLoS) conditions.

At the L₂ layer, obstructions to diagonal communication links between the WGNs are inevitably created by the vibroseis trucks, thus inhibiting direct data transfer along the shortest path from the WGNs to the DCC. Tall antennas can be deployed to counter this problem, albeit requiring several such setups across the entire survey area that are robust enough to tackle high wind speeds. Hence, a more tractable solution is to employ a directional radiation pattern at the L₂ layer, so as to relay data in a direction parallel to the SLs as shown in FIG. 7.

The topmost L₃ layer, comprising the DCC, forms the bottleneck of the entire network. Since the entire network topology is fixed for long durations of time, single-hop static routing can be applied. Considering a maximum antenna height of 1 meter at the WGNs and RNs, CCI between neighboring cells is effectively subdued by a larger path loss and a lower LoS probability at longer distances, implying that concurrent transmissions can occur between pairwise nodes.

As illustrated in FIG. 7, a “path” is defined as a set of WGNs and RNs, beginning from any outer WGN at the L₂ layer and leading up to the DCC. Each path comprises various “links” between adjacent WGNs. Each link is further divided into “sub-links” between adjacent RNs.

In addition to achieving real-time acquisition, power conservation is of vital importance not only in seismic survey applications, but many others. In the case of IEEE 802.11ad, the payload transmission time is significantly lesser as compared to the overhead time associated with the PHY header, inter-frame spaces, and MAC-layer backoff. For each data packet transmission, the overhead inadvertently leads to an increase in the power consumption.

In order to counter the impact of this overhead, FA techniques can be employed. As disclosed, multiple data packets can be aggregated into a single frame for transmission, thereby eliminating the recurrence of the overhead. The degree up to which FA is applied, i.e., the number of individual data packets that are aggregated, can be termed as the aggregation length. At the MAC layer, data is encapsulated into separate MSDUs, which can be aggregated to form the A-MSDU frame.

As shown in FIG. 2, the incoming MSDUs may be sequentially aggregated until a maximum size threshold is attained. An A-MSDU is then appended with a header and an FCS to form a MPDU. As per the chosen aggregation length, the requisite number of MPDUs are in turn aggregated into the A-MPDU frame. The A-MPDU frame is then passed in the egress direction to the PHY layer to form the final payload frame for transmission. A combination of both A-MSDU and A-MPDU frames has been shown to perform best.

The performance of FA can be further improved with block acknowledgements (BAs), where the acknowledgements for each of the MPDUs can be combined into a single frame. A block acknowledgement request (BAR) is sent by the transmitter after the A-MPDU frame, following which a BA is sent back by the receiver, which contains a bitmap corresponding to the MPDUs that have failed reception. Since each MPDU is associated with its own unique FCS for error detection, only those MPDUs that were not delivered successfully are required to be retransmitted. The overall effect is a substantial reduction in the amount of overhead that would otherwise be amplified in the case of individual data-acknowledgement exchanges.

The present invention provides effective power conservation. In addition to reducing the overhead with respect to time, FA can be exploited to achieve relatively large power savings. For instance, a geophone can abstain from transmitting data for a duration of sleep in order to buffer a requisite number of packets while conserving power, after which real-time acquisition can still be perceived through a burst transmission of the buffered data using FA. The FA-PSB scheme relies on a cross-layer analytical model and optimization framework to determine the sleep duration and other parameters for data transmission, such as the transmit power, MCS index, and the aggregation length. Overall, highly effective power conservation is achieved across the backhaul network while adhering to any latency constraints at the DCC.

IEEE 802.11 devices typically require a minimum duration of 250 μs to “wake-up” from sleep mode operation. Additionally, time synchronization should be maintained between adjacent nodes, where a timing synchronization function can provide an accuracy of 4 μs, which is negligible in comparison to the value of the minimum duration. Thus, the minimum duration can implicitly serve as a guard time for countering the possible effects of incorrect synchronization.

The present invention further provides robustness against CCI. CCI can lead to a decrease in the SINR at the receiver, which in turn can lead to a higher packet error rate. In general, the impact of CCI in the present inventive network is not severe, owing to a lower LoS probability and a higher path loss (due to atmospheric absorption) at larger distances. However, the FA-PSB scheme can operate in the presence of CCI as well.

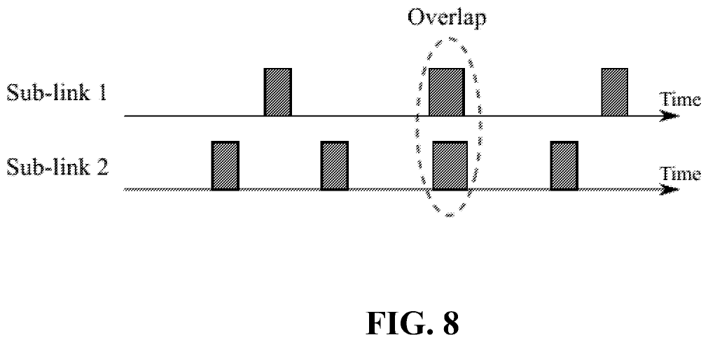

Given that the arrival rate of data at a node is deterministic, the resultant durations for operating in sleep mode and data transfer can be computed, following which the duty cycle for the corresponding sub-link can be found. As shown in FIG. 8, interference would occur between two co-channel cells when the data transmission periods (represented by the “on” state of the duty cycles) overlap. Since the occurrence of such overlapping transmissions can be found in a deterministic manner, the robustness of the sub-links can be ensured by altering the operating parameters such as the transmit power or the MCS index. These parameters can be obtained a-priori through a heuristic algorithm based on a combination of power and rate control that maintains a low outage probability. Hence, the deterministic nature of traffic in geophone networks can be exploited to compute the time instances when CCI would be present, following which the operating parameters are preemptively modified to ensure robustness against CCI.

The present invention further provides TCP over mesh networks with large hop-count. TCP is not well-suited for mesh networks with a large number of hops since an acknowledgement from the receiver that is delayed extensively would be interpreted as packet loss by the transmitter. This problem can be overcome by maintaining single-hop TCP links between adjacent RNs (and WGNs), rather than having a dedicated TCP connection between each of the WGNs and the DCC.

The present invention further provides standards-compliance: The present FA-PSB scheme is designed to be compliant with the TCP/IP protocol suite at the transport and network layers, along with the IEEE 802.11 protocol at the MAC and PHY layers. The functionality of the present FA-PSB scheme can be implemented by making appropriate changes to the device drivers or firmware, without requiring modifications to the specifications dictated by the relevant standards.

Modeling two surveys generally related to the architecture of FIG. 7 using the present invention illustrate the beneficial results. Considering a 4-cell reuse pattern and a sweep length of 8 seconds, the performance with respect to the latency and power consumption (at the L₂ and L₂ layers) is evaluated for a SA and a TX survey terrain.

The SA survey represents a mid-sized survey comprising 14,400 geophones over an area of 72 square kilometers, while the TX survey represents a large survey comprising 57,600 geophones over an area of 288 square kilometers. The resultant values are averaged over 1000 Monte Carlo trials, wherein the geophone network is deployed over a random section (as per a uniform distribution) of the seismic survey region in each trial.

Simulations are conducted using ns-3 for the IEEE 802.11ad standard. The simulation parameters are shown in Table I:

TABLE I
Simulation Parameters

| Parameter | Value | | Parameter | Value | |
|---|---|---|---|---|---|
| Operating | 57-64 | GHz | Maximum size of an | 7935 | bytes |
| Frequency | | | A-MSDU frame | | |
| Channel | 2.16 | GHz | Maximum size of an | 262,143 | bytes |
| Bandwidth | | | A-MPDU frame | | |
| Antenna Height | 1 | m | Supply Voltage (Vₛ) | 3 | V |
| Maximum EIRP | 51 | dBm | Current in transmit | 2776 | mA |
| | | | mode (Iₜₓ) | | |
| Noise Figure | 6 | dB | Current in receive | 2198 | mA |
| | | | mode (Iᵣₓ) | | |
| Outage probability | 10⁻⁶ | | Current in idle | 420 | mA |
| threshold (p_{th, out}) | | | mode (I_{idle}) | | |
| TCP Maximum | 2200 | bytes | Current in sleep | 5 | mA |
| Segment Size | | | mode (Iₛₗ) | | |

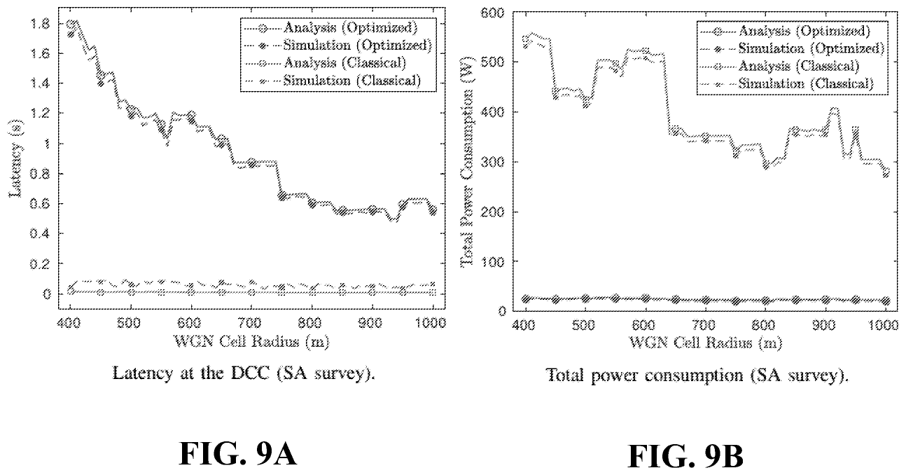

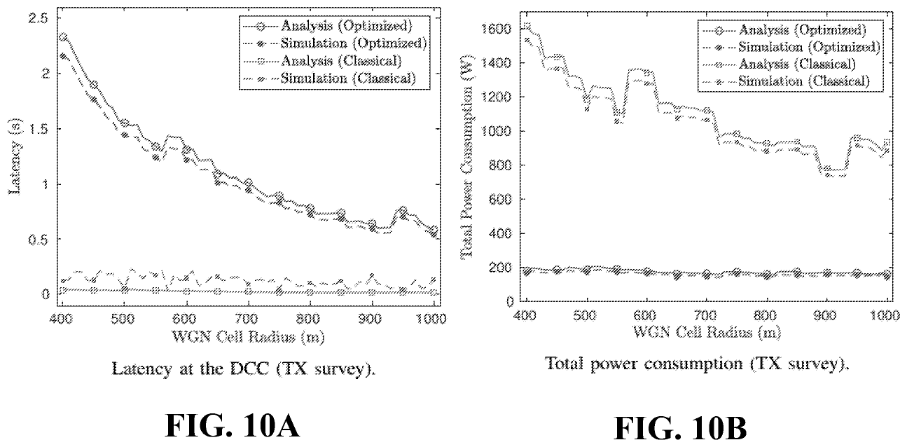

Standards-compliant values of a contention window size (CW) of CWₘᵢₙ=16 and CWₘₐₓ=1024 are considered, such that M=6 (where the TCP payload segment or TCP acknowledgement would have to be resent after M retransmissions at the MAC layer). The latency and the total power consumption for the SA and TX surveys operating under the FA-PSB scheme is shown in FIGS. 9A, 9B, 10A, and 10B as a function of the WGN cell radius R, for a geophone data generation rate of 144 Kbps. While the latency ranges between 0.5-2.2 seconds, which is well within the value of the sweep length, the power saving performance is abundantly clear, with a 78-87% drop in the total power consumption under the FA-PSB scheme as compared to the classical scenario (where there is no sleep duration imposed on the sub-links).

The number of WGNs decreases with increasing values of R, which explains the descending trend in the latency and power consumption. However, certain non-linearities are introduced in the trend since the total number of RNs does not monotonically decrease with R. For instance, an abrupt increase in the latency and the power consumption is seen in both surveys around R=570 meters. This is due to the fact that the outage probability threshold can only be met by the introduction of additional RNs. Hence, although it may seem counter-intuitive that the power consumption would increase despite a drop in the number of WGNs, it is important to consider the number of RNs that are required to sustain reliable and real-time acquisition for larger values of R.

FIGS. 10A, 10B illustrate that the overall latency and power consumption in the TX survey is larger as compared to the SA survey, which arises due to two factors. First, the TX survey area mandates a larger number of WGNs and RNs as it is four times larger in size. Second, the TX survey terrain is characterized by a lower LoS probability, which in turn would require a larger number of RNs to be deployed.

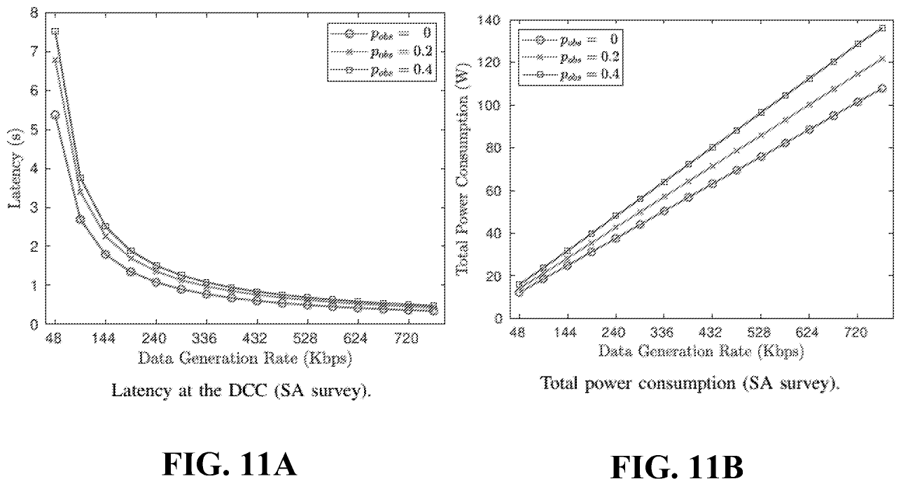

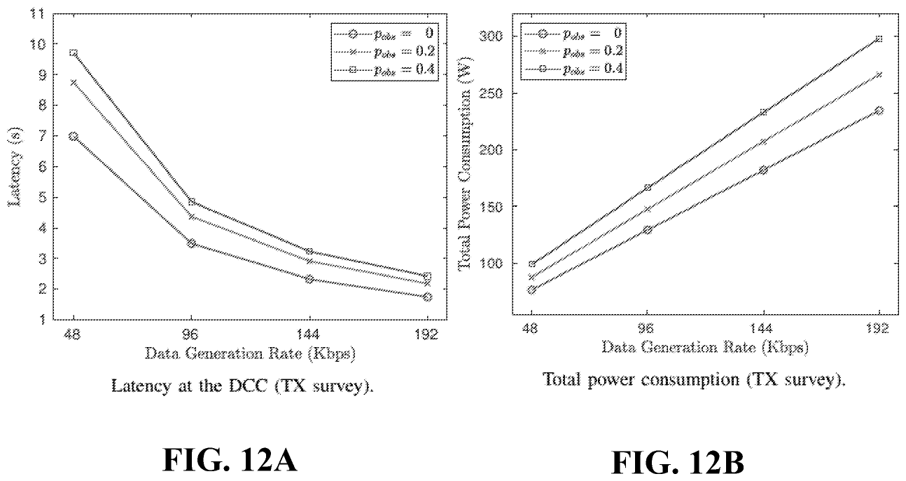

Furthermore, the effectiveness of the present analytical technique can be seen in FIGS. 9A, 9B, 10A, and 10B. The impact of the data generation rate at each of the geophones (multiples of 48 Kbps) is studied for R=400 meters. As seen in FIGS. 11A, 11B, a maximum rate of 768 Kbps can be sustained by the present 802.11ad-based architecture for the SA survey. The latency observes a decreasing trend in FIGS. 11A, 12A, since the sleep duration is reduced in order to maintain queue stability at higher values of the packet arrival rate. A corresponding increase is seen in the power consumption, where the WGNs and RNs are required to operate in transmit and receive modes for a greater fraction of time.

In the case of the TX survey, a maximum data generation rate of 192 Kbps can be applied at the geophones. Note that the analysis deals with the transfer of raw data from the geophones to the DCC. However, data compression techniques can be utilized to reduce the effective packet arrival rate, which in turn can substantially enhance the power conservation performance of the FA-PSB scheme.

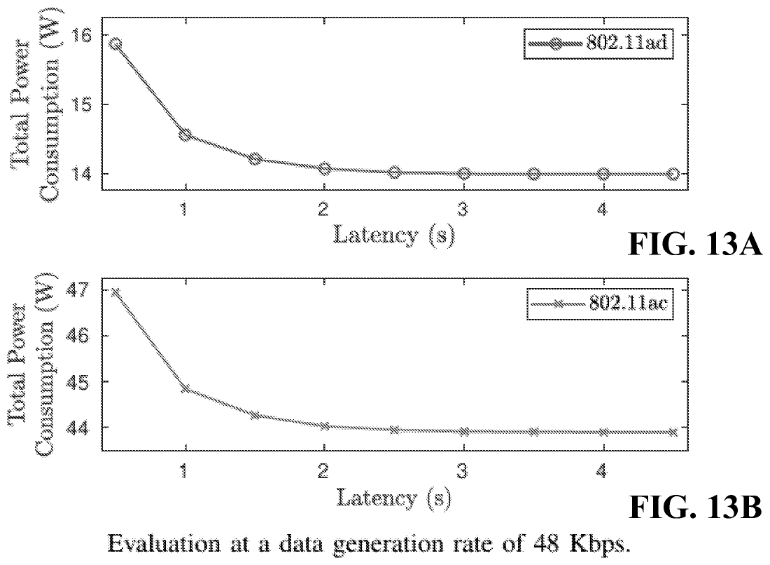

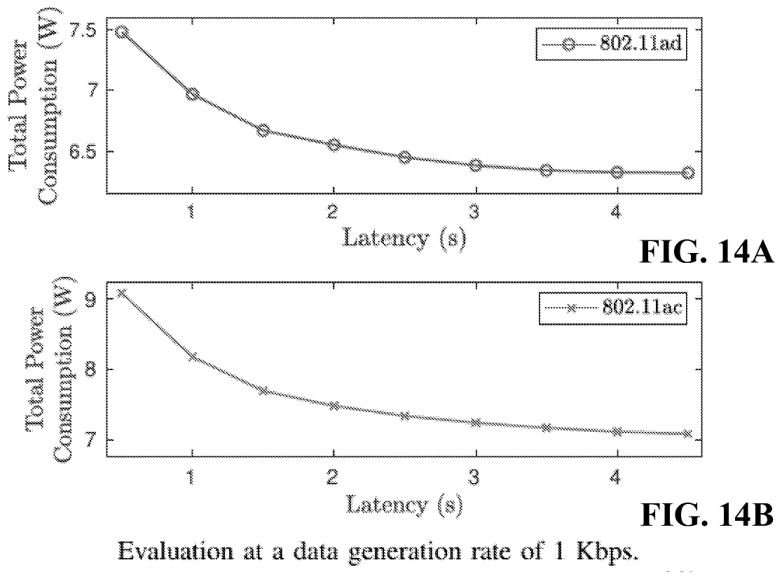

FIGS. 13A, 13B, 14A and 14B illustrates a performance comparison between the use of the IEEE 802.11ad and IEEE 802.11ac standards under a latency-constrained scenario for the SA survey. When low-rate alternative applications such as seismic quality control or earthquake detection are considered, where the data generation rate can be as low as 1 Kbps, a latency of several minutes may be introduced by the FA-PSB scheme. Thus, a latency constraint would be deemed necessary in such scenarios, at the cost of a marginal increase in the power consumption. The tradeoff between the latency and the power consumption is shown in FIGS. 13A, 13B, 14A and 14B for the SA survey and for R=400 meters. Considering a data generation rate of 48 Kbps in FIGS. 13A and 13B, it can be seen that the 802.11ad standard is able to achieve a much lower power consumption as compared to 802.11ac, by exploiting its gigabit-rate capability to increase the sleep duration while maintaining queue stability.

In the case of a data generation rate of 1 Kbps in FIGS. 14A and 14B, the power conservation benefit that is provided by the 802.11ad standard is only marginal as compared to the 802.11ac standard. Hence, the 802.11ac standard may be deemed a feasible choice in low-rate applications but fails to provide satisfactory results in the case of data-intensive seismic acquisition.

For instance, the maximum data generation rates that can be sustained by the 802.11ac standard are only 1 and 48 Kbps in the case of the SA survey, and just 1 Kbps in the case of the TX survey. Since the maximum PHY-layer rate is only around 440 Mbps for the standard 80 MHz channels, higher data generation rates at the geophones would lead to queue instability and an exponential latency at the DCC.

Seismic acquisition at the DCC, the final sink node for the entire geophone network, mandates data transfer rates on the order of several gigabits per second in order to have real-time data delivery, in addition to the acquisition process being energy-efficient. A wireless geophone network architecture based on the IEEE 802.11ad standard has been evaluated as disclosed under the impact of CCI for a combination of the seismic survey size, number of geophones, data generation rate, and survey terrain in Saudi Arabia and Texas, USA.

On the basis of statistical models for the path loss and LoS probability, and a cross-layer analytical model for the latency and power consumption, an optimization framework is developed to achieve near-optimal power conservation performance through the FA-PSB scheme. A performance evaluation at a data generation rate of 144 Kbps reveals that the power consumption can be reduced by up to 87% with a maximum latency of around 2 seconds at the DCC, as compared to classical operation prescribed by the 802.11ad standard. Although approaches based on the IEEE 802.11ac standard are feasible for low-rate applications such as earthquake detection and seismic quality control, the present invention's use of the IEEE 802.11ad standard is far more suitable for data-intensive real-time environments, like seismic acquisition.

The power conservation performance of the FA-PSB scheme can be further enhanced by utilizing a higher value for an upper bound on the aggregation length, which could be tweaked in vendor-specific implementations to support larger A-MPDU frame sizes. Additionally, data compression techniques can be incorporated to reduce the overall packet arrival rate at the WGNs, which in turn would enable the FA-PSB scheme to conserve more power. A reduction in the power consumption translates to a reduced cost in terms of the equipment weight, transportation, and manpower. The present architecture also offers a low-cost alternative to current seismic data acquisition systems by eliminating cable and reducing the overall power consumption. Furthermore, the FA-PSB scheme can find application in cellular backhaul and large-scale sensor networks for effective power conservation.

While certain embodiments of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method of controlling power consumption comprising:
operating a first electronic device of a wireless network in a first low-power sleep mode for a first sleep mode duration; and
operating the first electronic device in a first active mode;
wherein in the first active mode, the first electronic device is configured to transmit or receive a first active mode amount of data via:
a burst transmission; or
an aggregate frame transmission;
wherein the first sleep mode duration is based at least in part upon a first data arrival rate; and
wherein one or both:
a power consumption of the first electronic device during a time period operating in the first low-power sleep mode is approximately at least 78% less than a power consumption of the first electronic device during a time period without operating in the first low-power sleep mode; and/or
the method further comprises synchronously operating each of the first electronic device and a second electronic device in the first low-power sleep mode for the first sleep mode duration, followed by a continuous transmission by the first electronic device, and a continuous reception by the second electronic device, of the first active mode amount of data in the form of individual data frames or in the form of one or more aggregate frames.

2. The method of claim 1, wherein the first electronic device has a first maximum data communication rate; and
wherein the first electronic device operates in the first low-power sleep mode when the first maximum data communication rate exceeds the first data arrival rate.

3. The method of claim 1, wherein one or more of:
the first sleep mode duration is based upon the first arrival rate of the wireless data and the first active mode amount of data;
the burst transmission comprises a continuous transmission of individual data frames;
the aggregate frame transmission comprises a continuous transmission of one or more aggregate frames;
the first active mode amount of data is based upon a requirement imposed by one or more of the first electronic device, another device of the wireless network, and/or a backbone network associated with the wireless network;
the first active mode amount of data is based upon a power consumption requirement imposed by one or more of the first electronic device, another device of the wireless network, and/or a backbone network associated with the wireless network;
the first active mode amount of data is based upon a latency requirement imposed by one or more of the first electronic device, another device of the wireless network, and/or a backbone network associated with the wireless network;
the first active mode amount of data is based upon a buffer size requirement imposed by one or more of the first electronic device, another device of the wireless network, and/or a backbone network associated with the wireless network;
the first active mode amount of data is based upon a traffic category of data requirement imposed by one or more of the first electronic device, another device of the wireless network, and/or a backbone network associated with the wireless network;
the first active mode amount of data is based upon a uniformity of power consumption requirement imposed by one or more of the first electronic device, another device of the wireless network, and/or a backbone network associated with the wireless network; and
the first active mode amount of data is based upon a first communication rate of a first communication link associated with the first electronic device.

4.-6. (canceled)

7. The method of claim 1, wherein the first active mode amount of data is based upon a requirement imposed by one or more of the first electronic device, another device of the wireless network, and/or a backbone network associated with the wireless network; and
wherein the requirement is selected from the group consisting of power consumption, latency, buffer size, a traffic category of data, uniformity of power consumption, communication rate, and transmission power.

8.-14. (canceled)

15. The method of claim 1 further comprising:
determining the first data arrival rate; and
determining the first active mode amount of data;
wherein the first sleep mode duration is chosen as a function of the determined first data arrival rate and the determined first active mode amount of data.

16. The method of claim 15, wherein one or more of:
the first data arrival rate is determined using a deterministic technique;
the first data arrival rate is determined using a statistical technique;
the first active mode amount of data is determined as a function of one or more parameters selected from the group consisting of latency, power consumption, uniformity of power consumption, quality-of-service (or traffic category of the data), buffer size, communication rate (or MCS index), and transmission power;
the first active mode amount of data is determined by a power consumption requirement imposed by one or more of the first electronic device, another device of the wireless network, and/or a backbone network associated with the wireless network;
the first active mode amount of data is determined by a latency requirement imposed by one or more of the first electronic device, another device of the wireless network, and/or a backbone network associated with the wireless network;
the first active mode amount of data is determined by a buffer size requirement imposed by one or more of the first electronic device, another device of the wireless network, and/or a backbone network associated with the wireless network;
the first active mode amount of data is determined by a traffic category requirement imposed by one or more of the first electronic device, another device of the wireless network, and/or a backbone network associated with the wireless network;
the first active mode amount of data is determined by a uniformity of power consumption requirement imposed by one or more of the first electronic device, another device of the wireless network, and/or a backbone network associated with the wireless network;
the first active mode amount of data is determined by a first communication rate of a first communication link associated with the first electronic device; and
the first active mode amount of data is determined by a transmission power of the first electronic device.

17.-25. (canceled)

26. A method of controlling power consumption of stations in a wireless network comprising:
operating a first transmitter of a first station in the wireless network in a first transmitter low-power sleep mode for a first sleep mode duration;
subsequently operating the first transmitter to continuously transmit a first amount of data via:
a burst transmission; or
an aggregate frame transmission; and
operating a second receiver of a second station in the wireless network to continuously receive the first amount of data in the form of the burst transmission or the aggregate frame transmission;
wherein the first sleep mode duration is based at least in part upon a first arrival rate of data at the first station; and
wherein one or more:
a power consumption of the first transmitter during a time period operating in the first sleep mode is approximately at least 78% less than a power consumption of the first transmitter during a time period without operating in the sleep mode;
the method further comprises synchronously operating each of the first transmitter and the second receiver in the first sleep mode for the first sleep mode duration, followed by the continuous transmission by the first transmitter, and the continuous reception by the second receiver, of the first amount of data in the form of individual data frames or in the form of one or more aggregate frames; and/or
the method further comprises operating a second transmitter of the second station in a second transmitter low-power sleep mode for a second sleep mode duration, wherein after the second sleep mode duration, the second transmitter continuously transmits a second amount of data via a burst transmission or an aggregate frame transmission, wherein the first sleep mode duration is based on a first arrival rate of data to the first station and the first amount of data, and wherein the second sleep mode duration is based on a second arrival rate of data to the second station and the second amount of data.

27. The method of claim 26 further comprising:
determining the first arrival rate of data; and
determining the first amount of data;
wherein the first sleep mode duration is chosen as a function of the determined first arrival rate of data and the determined first amount of data.

28. The method of claim 27, wherein the transmission of the first amount of data comprises a multicast transmission that is destined for reception by a plurality of other stations in the wireless network.

29. The method of claim 27, wherein the burst transmission comprises a continuous transmission of individual data frames;
wherein the aggregate frame transmission comprises a continuous transmission of one or more aggregate frames; and
wherein the transmission of the first amount of data comprises a multicast transmission that supports a unique rate for each of the individual data frames or aggregate frames.

30. The method of claim 27 further comprising:
operating the second receiver in a second receiver low-power sleep mode for the first sleep mode duration.

31. (canceled)

32. The method of claim 30 further comprising:
operating a third receiver of a third station in the wireless network in a third receiver low-power sleep mode for the second sleep mode duration; and
subsequently operating the third receiver to continuously receive the second amount of data in the form of the burst transmission or the aggregate frame transmission.

33. The method of claim 32, wherein a communication link between the first transmitter and the second receiver operates concurrently with a communication link between the second transmitter and the third receiver.

34. The method of claim 33, wherein the communication link between the first transmitter and the second receiver operates over a frequency band F1;
wherein the communication link between the second transmitter and the third receiver operates over a frequency band F2; and
wherein the frequency bands F1 and F2 are distinct from one another.

35. The method of claim 30 further comprising operating the second receiver in a wake-up mode for a wake-up mode duration;
wherein the second receiver is configured to receive a transmission from a third station in the wireless network;
wherein a duration of the transmission from the third station is at least approximately equal to the wake-up mode duration; and
wherein the wake-up mode duration is less than or equal to the first sleep mode duration.

36.-46. (canceled)

47. A method of controlling power consumption of at least two electronic devices in a wireless network comprising:
determining a first data arrival rate at a first electronic device in the wireless network;
determining a first amount of data for transmission by the first electronic device to a second electronic device in the wireless network; and
synchronously operating the first electronic device and the second electronic device in a low-power sleep mode for a common duration, followed by a continuous transmission by the first electronic device, and continuous reception by the second electronic device, of the first amount of data in the form of individual data frames or in the form of one or more aggregate frames;
wherein the common duration of the low-power sleep modes is chosen as a function of the first data arrival rate and the first amount of data.

48.-53. (canceled)

54. The method of claim 47 further comprising operating the second electronic device in a wake-up mode for a wake-up mode duration;
wherein the second electronic device is configured to receive a transmission from a third electronic device in the wireless network;
wherein a duration of the transmission from the third electronic device is at least approximately equal to the wake-up mode duration; and
wherein the wake-up mode duration is less than or equal to the common duration.

55. A method of controlling power consumption of stations in a wireless network comprising:
operating a first transmitter of a first station in the wireless network in a first transmitter low-power sleep mode for a first sleep mode duration;
operating a second receiver of a second station in the wireless network in a second receiver low-power sleep mode for the first sleep mode duration; and
operating a second transmitter of the second station in a second transmitter low-power sleep mode for a second sleep mode duration;
wherein after the first sleep mode duration, the first transmitter continuously transmits a first amount of data via a burst transmission or an aggregate frame transmission;
wherein after the first sleep mode duration, the second receiver continuously receives the first amount of data via the burst transmission or the aggregate frame transmission;
wherein after the second sleep mode duration, the second transmitter continuously transmits a second amount of data via a burst transmission or an aggregate frame transmission;
wherein the first sleep mode duration is based on a first arrival rate of data to the first station and the first amount of data; and
wherein the second sleep mode duration is based on a second arrival rate of data to the second station and the second amount of data.

56.-68. (canceled)

69. The method of claim 55 further comprising operating the second receiver in a wake-up mode for a wake-up mode duration;
wherein the second receiver is configured to receive a transmission from a third station in the wireless network;
wherein a duration of the transmission from the third station is at least approximately equal to the wake-up mode duration; and
wherein the wake-up mode duration is less than or equal to the first sleep mode duration.

70.-78. (canceled)

79. A computer-implemented method of controlling power consumption of at least two electronic devices in a wireless network comprising:
determining a first data arrival rate at a first electronic device in the wireless network;
determining a first amount of data for transmission by the first electronic device to a second electronic device in the wireless network; and
synchronously operating the first electronic device and the second electronic device in a low-power sleep mode for a common duration, followed by a continuous transmission by the first electronic device, and continuous reception by the second electronic device, of the first amount of data in the form of individual data frames or in the form of one or more aggregate frames;
wherein the common duration of the low-power sleep modes is chosen as a function of the first data arrival rate and the first amount of data.

80.-82. (canceled)

83. A computer-implemented method of controlling power consumption of stations in a wireless network comprising:
operating a first transmitter of a first station in the wireless network in a first transmitter low-power sleep mode for a first sleep mode duration;
operating a second receiver of a second station in the wireless network in a second receiver low-power sleep mode for the first sleep mode duration; and
operating a second transmitter of the second station in a second transmitter low-power sleep mode for a second sleep mode duration;
wherein after the first sleep mode duration, the first transmitter continuously transmits a first amount of data via a burst transmission or an aggregate frame transmission;
wherein after the first sleep mode duration, the second receiver continuously receives the first amount of data via the burst transmission or the aggregate frame transmission;
wherein after the second sleep mode duration, the second transmitter continuously transmits a second amount of data via a burst transmission or an aggregate frame transmission;
wherein the first sleep mode duration is based on a first arrival rate of data to the first station and the first amount of data; and
wherein the second sleep mode duration is based on a second arrival rate of data to the second station and the second amount of data.

84.-132. (canceled)

133. A system of controlling power consumption of at least two electronic devices in a wireless network comprising:
memory configured to store data;
a first electronic device in the wireless network;
a first electronic device in the wireless network; and
one or more processors communicative with the memory configured to:
determine a first data arrival rate at the first electronic device;
determine a first amount of data for transmission by the first electronic device to the second electronic device; and
synchronously operate the first electronic device and the second electronic device in a low-power sleep mode for a common duration, followed by a continuous transmission by the first electronic device, and continuous reception by the second electronic device, of the first amount of data in the form of individual data frames or in the form of one or more aggregate frames;
wherein the common duration of the low-power sleep modes is chosen as a function of the first data arrival rate and the first amount of data.

134. The system of claim 133, wherein the transmission of the first amount of data comprises a multicast transmission that is destined for reception by the second electronic device and other electronic devices in the wireless network.

135.-140. (canceled)

141. A system of controlling power consumption of stations in a wireless network comprising:
memory configured to store data;
a first transmitter of a first station in the wireless network;
a second receiver of a second station in the wireless network;
a second transmitter of the second station; and
one or more processors communicative with the memory configured to:
operate the first transmitter in a first transmitter low-power sleep mode for a first sleep mode duration;
operate the second receiver in a second receiver low-power sleep mode for the first sleep mode duration; and
operate the second transmitter in a second transmitter low-power sleep mode for a second sleep mode duration;
wherein after the first sleep mode duration, the first transmitter continuously transmits a first amount of data via a burst transmission or an aggregate frame transmission;
wherein after the first sleep mode duration, the second receiver continuously receives the first amount of data via the burst transmission or the aggregate frame transmission;
wherein after the second sleep mode duration, the second transmitter continuously transmits a second amount of data via a burst transmission or an aggregate frame transmission;
wherein the first sleep mode duration is based on a first arrival rate of data to the first station and the first amount of data; and
wherein the second sleep mode duration is based on a second arrival rate of data to the second station and the second amount of data.

142.-164. (canceled)

165. A non-transitory computer-readable medium having stored thereon computer-readable instructions executable to cause a computer to perform a method for controlling power consumption of at least a first station in a wireless network, the method comprising:
determining a first data arrival rate at a first electronic device in the wireless network;
determining a first amount of data for transmission by the first electronic device to a second electronic device in the wireless network; and
synchronously operating the first electronic device and the second electronic device in a low-power sleep mode for a common duration, followed by a continuous transmission by the first electronic device, and continuous reception by the second electronic device, of the first amount of data in the form of individual data frames or in the form of one or more aggregate frames;
wherein the common duration of the low-power sleep modes is chosen as a function of the first data arrival rate and the first amount of data.

166.-168. (canceled)

169. A non-transitory computer-readable medium having stored thereon computer-readable instructions executable to cause a computer to perform a method for controlling power consumption of at least a first station in a wireless network, the method comprising:
operating a first transmitter of a first station in the wireless network in a first transmitter low-power sleep mode for a first sleep mode duration;
operating a second receiver of a second station in the wireless network in a second receiver low-power sleep mode for the first sleep mode duration; and
operating a second transmitter of the second station in a second transmitter low-power sleep mode for a second sleep mode duration;
wherein after the first sleep mode duration, the first transmitter continuously transmits a first amount of data via a burst transmission or an aggregate frame transmission;
wherein after the first sleep mode duration, the second receiver continuously receives the first amount of data via the burst transmission or the aggregate frame transmission;
wherein after the second sleep mode duration, the second transmitter continuously transmits a second amount of data via a burst transmission or an aggregate frame transmission;
wherein the first sleep mode duration is based on a first arrival rate of data to the first station and the first amount of data; and
wherein the second sleep mode duration is based on a second arrival rate of data to the second station and the second amount of data.

170.-172. (canceled)

173. A method of controlling power consumption of an electronic device in a wireless network comprising:
operating the electronic device over a time period comprising:
operating the electronic device in a low-power sleep mode for a sleep mode duration in the time period; and
operating the electronic device in an active mode for an active mode duration in the time period;
wherein in the active mode, the electronic device is configured to transmit or receive an active mode amount of data via:
a burst transmission; or
an aggregate frame transmission;
wherein a power consumption of the electronic device during the time period operating in the low-power sleep mode is approximately at least 78% less than a power consumption of the electronic device during the time period without operating in the low-power sleep mode.

174. The method of claim 173, wherein the power consumption of the electronic device during the time period operating in the low-power sleep mode is approximately at least 87% less than the power consumption of the electronic device during the time period without operating in the low-power sleep mode.

175.-188. (canceled)
